(19) United States
(12) Patent Application Publication
(10) Pub. No.: US 2006/0085611 A1
(43) Pub. Date: Apr. 20, 2006

(54) Method of managing multistage copied data

(75) Inventors: Hirokazu Ikeda, Yamato (JP); Masahide Sato, Noda (JP); Atsushi Takahashi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/024,569

(22) Filed: Dec. 28, 2004

(30) Foreign Application Priority Data
Oct. 18, 2004 (JP) 2004-303274

(51) Int. Cl. G06F 12/16

(52) U.S. Cl. 711/162

(57) ABSTRACT

Provided is a computer system comprising a system management server, an application server coupled to the system management server, and a storage system coupled to the application server. The storage system comprises logical volumes which constitute a pair through data copying. The system management server comprises a data management unit which manages data stored in the logical volumes, and management information for managing the data stored in the logical volumes and the pair. Upon reception of a request for changing a pair status, the data management unit refers to the management information to determine data to be lost from the logical volume by performing the change, and outputs information regarding the data to be lost. Thus, it is possible to prevent occurrence of data loses not intended by a user which is caused by the user performing a pair operation in data copying of a cascade structure.

### CLAIM OF PRIORITY

The present application claims priority from Japanese application P2004-303274 filed on Oct. 18, 2004, the content of which is hereby incorporated by reference into this application.

### BACKGROUND

This invention relates to data management of a storage system which uses a data copying technology.

In a data storage market, there is a demand for a so-called disaster recovery system which prevents data loss even when a storage system storing a great volume of data is destroyed by a disaster or the like. To meet such a market demand, there has been proposed a computer system which backs up data by using a data copying technology. According to this system, data is copied between two logical volumes, and identical data are stored in the logical volumes. The two logical volumes may be in the same storage system, or in two storage systems geographically separated from each other (see JP 2003-345522 A, for example).

Furthermore, there has been proposed a method of managing backup data of different generations by using the data copying technology (JP 2004-164318 A). According to this method, one primary logical volume makes data copying pairs with secondary logical volumes, and backup data of different generations of the primary logical volume is stored in each secondary logical volume.

### SUMMARY

There has recently been emerged a data copying technology of a so-called cascade structure which connects data copying pairs in multistages. In a copy path of the pairs thus connected in multistages, when data of a logical volume on an upstream side is updated, the updated data is copied along the copy path, and spread to a logical volume on a downstream side. By controlling execution or stop of data copying of the pair on the midway of the copy path, it is possible to manage backup data of different generations.

In such data copying of the cascade structure, when a user changes a pair status of the upstream side of the copy path, an influence of the change may spread even to a logical volume on a most downstream side of the copy path. For example, in the pair of the upstream side, resumption of stopped data copying may cause updating of data of the logical volume on the downstream side apart from the pair. Consequently, for example, a data loss not intended by the user, such as a loss of backup data of a specific generation, may occur.

This invention has been made in view of the above-mentioned problem, and it is therefore an object of this invention to provide a computer system that constitutes a multistage structure and utilizes a data copy technique for backing up data.

This invention provides a computer system comprising: a storage system; and a system management server which manages the computer system including the storage system, wherein: the storage system comprises: a primary logical volume which stores data; and a secondary logical volume which stores a copy of the data stored in the primary logical volume, the primary logical volume and the secondary logical volume constituting a pair; the system management server: comprises a data management unit which manages the data stored in the logical volumes; and stores management information to manage the data stored in the logical volumes and the pair; and upon reception of a request for changing a pair status, the data management unit refers to the management information and determines data to be lost from the logical volume by the changing of the pair status, and outputs information regarding the data to be lost.

According to this invention, it is possible to prevent occurrence of a data loss not intended by the user which is caused by an application status change or pair status change.

### BRIEF DESCRIPTION OF THE DRAWINGS

FIG. 1 is a block diagram showing a configuration of a computer system according to an embodiment of this invention.

FIG. 2 is an explanatory diagram showing contents of a disk device of a system management server according to the embodiment of this invention.

FIG. 3 is an explanatory diagram showing contents of a disk device of an application server according to the embodiment of this invention.

FIG. 4 is an explanatory diagram showing a data copying pair and a copy group according to the embodiment of this invention.

FIG. 5 is an explanatory diagram showing a pair status/application status management table according to the embodiment of this invention.

FIG. 6 is an explanatory diagram showing a volume/data correspondence management table according to the embodiment of this invention.

FIG. 7 is an explanatory diagram showing a pair constitution definition table according to the embodiment of this invention.

FIG. 8 is a flowchart of a process executed by a data management program when a user requests a pair operation in the computer system according to the embodiment of this invention.

FIG. 9 is an explanatory diagram showing information regarding data to be lost by a pair operation which is output by the data management program according to the embodiment of this invention.

FIG. 10 is a flow chart of a process executed by the data management program when a pair operation is requested by a batch job in the computer system according to the embodiment of this invention.

FIG. 11 is an explanatory diagram showing a process of determining data to be lost by a pair operation according to the embodiment of this invention.

FIG. 12 is a flowchart showing a process of determining data to be lost by the pair operation according to the embodiment of this invention.

FIG. 13 is a flowchart showing a table updating process after the pair operation according to the embodiment of this invention.

FIG. 14 is a flowchart showing a process executed by the data management program when the user requests an application status change or pair operation in the computer system according to the embodiment of this invention.

FIG. 15 is a flowchart showing a process executed by the data management program when an application status change or pair operation is requested by a batch job in the computer system according to the embodiment of this invention.

FIG. 16 is a flowchart showing a process of determining data to be lost by the application status change or pair operation according to the embodiment of this invention.

FIG. 17 is a flowchart showing a table updating process after the application status change or pair operation according to the embodiment of this invention.

FIG. 18 is a flow chart showing a process executed by the data management program when data is lost by the application status change or pair operation according to the embodiment of this invention.

FIG. 19 is a flowchart showing a process of searching for a logical volume which becomes a candidate for data moving destination executed according to the embodiment of this invention.

FIG. 20 is an explanatory diagram showing screen display of the data to be lost and the candidates for data moving destination according to the embodiment of this invention.

### DETAILED DESCRIPTION OF THE PREFERRED EMBODIMENT

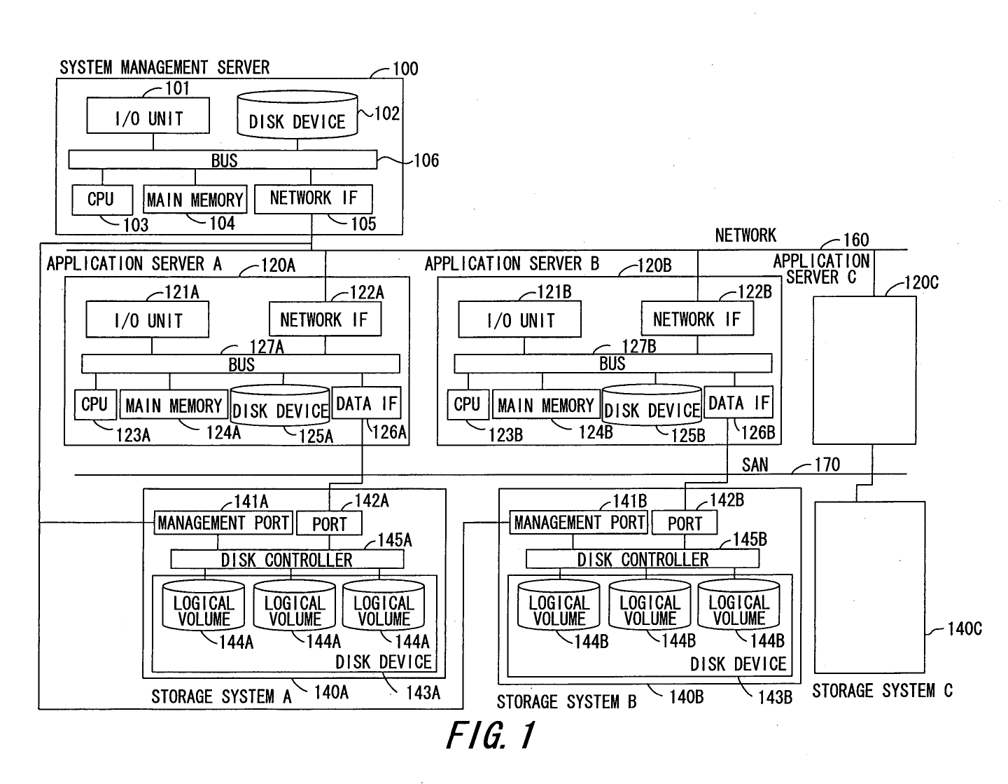

FIG. 1 is a block diagram showing a configuration of a computer system according to an embodiment of this invention.

The computer system of this embodiment includes a system management server 100, one or more application servers 120, and one or more storage systems 140.

The system management server 100 and the application server 120 are interconnected through a network 160 to communicate with each other. For example, the network 160 is LAN or IP network such as the Internet.

The application server 120 and the storage system 140 are interconnected through a storage area network (SAN) 170 to communicate with each other. The SAN 170 is a storage-specific network, and communication is performed based on an FC protocol, an FCIP protocol, or the like.

The storage system 140 may further be connected through the network 160 to the system management server 100 or the like to communicate therewith.

The system management server 100 is a computer which manages the computer system of this embodiment. The system management server 100 includes an I/O unit 101, a disk device 102, a CPU 103, a main memory 104, and a network interface (I/F) 105, and a bus 106 for connecting these components.

The I/O unit 101 is a display screen (display), a keyboard, a mouse, or the like.

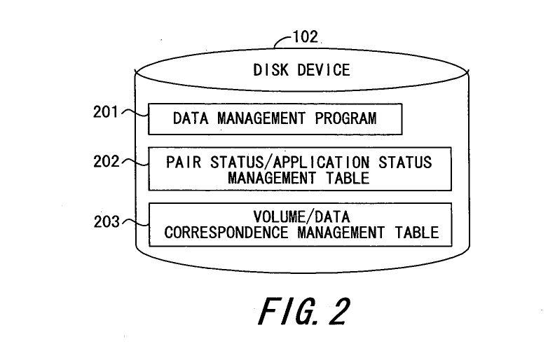

The disk device 102 is, for example, one hard disk drive, and stores a program executed by the CPU 103 and data necessary when the program is executed as shown in FIG. 2.

The CPU 103 is a processor which controls the system management server 100, and executes the program stored in the disk device 102.

The main memory 104 is, for example, a semiconductor memory, and used when the CPU 103 executes the program.

The network I/F 105 is an interface which enables the system management server 100 to communicate with the application server 120 or the like through the network 160.

The application server 120 is a computer which provides a file system by using the storage system 140, and assists user's applications by executing an application such as DBMS. The application server 120 includes an I/O unit 121, a network I/F 122, a CPU 123, a main memory 124, a disk device 125, a data I/F 126, and a bus 127 for connecting these components.

The I/O unit 121 is a display screen (display), a keyboard, a mouse, or the like.

The network I/F 122 is an interface which enables the application server 120 to communicate with the system management server 100 or the like through the network 160.

The CPU 123 is a processor which controls the application server 120, and executes the program stored in the disk device 125.

The main memory 124 is, for example, a semiconductor memory, and used when the CPU 123 executes the program.

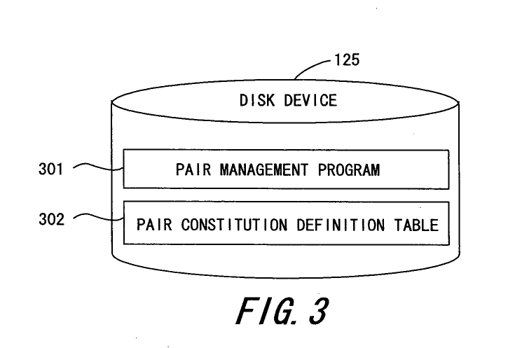

The disk device 125 is, for example, one hard disk drive, and stores a program executed by the CPU 123 and data necessary when the program is executed as shown in FIG. 3.

The data I/F 126 is an interface which enables the application server 120 to communicate with the storage system 140 or the like through the SAN 170.

An application server 120C (not shown) is similar in configuration to application servers 120A and 120B. The computer system of this embodiment may include more application servers 120.

The storage system 140 stores data according to a request from the application server 120.

The storage system 140 includes a management port 141, a port 142, a disk device 143, and a disk controller 145 which controls these components.

The management port 141 is an interface which enables the storage system 140 to communicate with the system management server 100 or the like through the network 160. It should be noted that, the storage system 140 may not be connected to the network 160. If the storage system 140 is not connected to the network 160, the management port 141 is unnecessary.

The port 142 is an interface which enables the storage system 140 to communicate with the application server 120 or the like through the SAN 170.

A logical volume 144 may include a plurality of hard disk drives (e.g., RAID). According to this embodiment, each logical volume 144 is assumed to be a RAID which includes a plurality of hard disk drives.

The logical volume is a storage area logically treated as one disk drive. Data used by the application server 120 is stored in any one of the logical volumes 144.

A storage system 140C is not shown in detail because it is similar in configuration to storage systems 140A and 140B. The computer system of this embodiment may include more storage systems 140.

The data stored in the logical volume 144 of the storage system 140 can be copied to a logical volume 144 of another storage system 140 not through the application server 120 but through the SAN 170. Such data copying is called remote copying. In addition, the data stored in the logical volume 144 of the storage system 140 can be copied to another logical volume 144 of the same storage system 140. Such data copying is called local copying.

Thus, when the data is copied between the logical volumes 144, concerning the logical volume 144 as the copy source and the logical volume 144 as the copy destination, two volumes make a pair. The logical volume 144 as the copy source is referred to as a primary logical volume (PVOL), and the logical volume 144 as the copy destination is referred to as a secondary logical volume (SVOL).

FIG. 2 is an explanatory diagram showing contents of the disk device 102 of the system management server 100 according to the embodiment of this invention.

The disk device 102 stores at least a data management program 201, a pair status/application status management table 202, and a volume/data correspondence management table 203. Configurations of the program and the table will be detailed later.

FIG. 3 is an explanatory diagram showing contents of the disk device 125 of the application server 120 according to the embodiment of this invention.

The disk device 125 stores at least a pair management program 301 and a pair constitution definition table 302.

The pair management program 301 receives instructions from the system management server 100 or the like, and executes a pair operation to switch a pair status of the logical volumes 144.

There are four pair statuses, i.e., “PAIR”, “SUSPEND”, “COPY”, and “ERROR”.

The “PAIR” is a status in which identical data are stored in the PVOL and the SVOL as a result of data copying. When the data of the PVOL of the pair in the “PAIR” status is updated, the updated data is copied to the SVOL by data copying (local or remote copying). Thus, data consistency is maintained between the PVOL and the SVOL.

The “SUSPEND” is a status in which data copying is stopped. Even when the data of the PVOL of the pair in the “SUSPEND” status is updated, the updated data is not copied to the SVOL. Thus, different data may be stored in the PVOL and the SVOL of the pair in the “SUSPEND” status.

The “COPY” is a status in which data copying is executed to switch the “SUSPEND” status to the “PAIR” status.

There are three pair operations executed by the pair management program 301, i.e., “SPLIT”, “RESYNC”, and “REVERSE-RESYNC”. The “REVERSE-RESYNC” is also called “RESTORE”.

When “SPLIT” is executed for the pair in the “PAIR” status, the pair becomes a “SUSPEND” status.

When “RESYNC” is executed for the pair in the “SUSPEND” status, the pair becomes a “COPY” status, and the data of the PVOL is copied to the SVOL. When the copying is finished, the pair becomes a “PAIR” status.

When “RESTORE” is executed for the pair in the “SUSPEND” status, the pair becomes a “COPY” status, and the data of the SVOL is copied to the PVOL. When the copying is finished, the pair becomes a “PAIR” status.

The above-mentioned pair operations executed by the pair management program 301 are similar to those executed in conventional data copying.

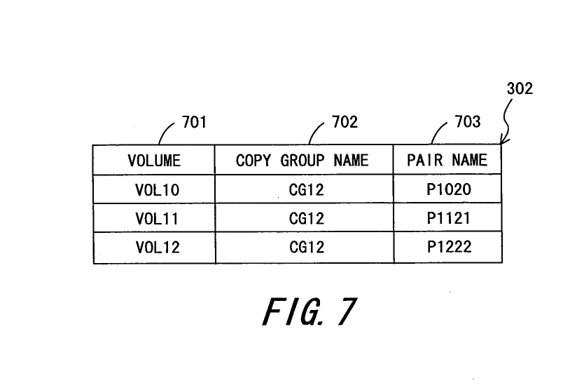

The pair constitution definition table 302 contains information regarding a pair of the logical volumes in the storage system 140 accessed by the application server 120. Referring to FIG. 7, the pair constitution definition table will be detailed later.

It should be noted that the pair management program 301 and the pair constitution definition table 302 may be stored in the disk device 102 of the system management server 100. In this case, the pair management program 301 executes a pair operation for the logical volumes 144 in the storage system 140 through the management port 141 connected to the network 160.

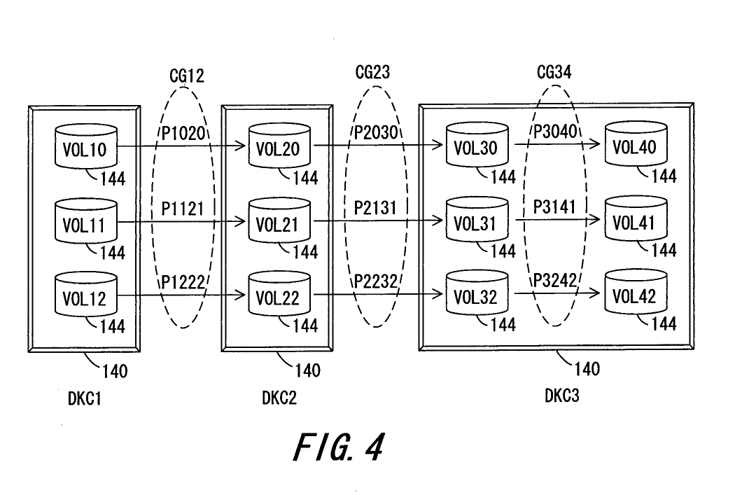

FIG. 4 is an explanatory diagram showing a data copying pair and a copy group according to the embodiment of this invention.

In the example of FIG. 4, DKC1, DKC2, and DKC3 serve as the storage systems 140. For example, the DKC1, the DKC2, and the DKC3 may serve as the storage systems 140A, 140B, and 140C, respectively. In FIG. 4, the SAN 170, the application server 120, and the like are omitted.

The DKC1 includes three logical volumes 144, i.e., VOL10, VOL11, and VOL12. The DKC2 includes three logical volumes 144, i.e., VOL20, VOL21, and VOL22. The DKC3 includes six logical volumes 144, i.e., VOL30, VOL31, VOL32, VOL40, VOL41, and VOL42.

Data of the VOL10 is copied to the VOL20 between the DKC1 and the DKC2. In other words, the VOL10 and the VOL20 make a pair. The VOL10 is PVOL, and the VOL20 is SVOL. The pair of the VOL10 and the VOL20 is set as a pair P1020.

Similarly, the VOL11 and the VOL21 make a pair P1121. The VOL11 is PVOL, and the VOL21 is SVOL.

The VOL12 and the VOL22 make a pair P1222. The VOL12 is PVOL, and the VOL22 is SVOL.

The three pairs are made by remote copying between the DKC1 and the DKC2.

The pairs P1020, P1121, and P1222 constitute a copy group CG12. The copy group is a set of pairs, and can be set as a pair operation unit. The pair operation unit is a unit for collectively performing a plurality of pair operations. When the copy group guarantees data consistency, in one copy group, updating of PVOL is accompanied by updating of SVOL in an updating sequence thereof. For example, when data A (not shown) of the VOL10 is updated, and data B (not shown) of the VOL11 is next updated, the data A is copied from the VOL10 to the VOL20, and the data B is next copied from the VOL11 to the VOL21. The updating sequence of data is maintained in such a manner, whereby data consistency is maintained in the copy group.

For example, a plurality of pairs regarding one instance of one application may be integrated in one copy group, or a plurality of pairs regarding one database may be integrated in one copy group.

Similarly, the VOL20, the VOL21, and the VOL22 make pairs P2030, P2131, and P2232 with the VOL30, the VOL31, and the VOL32 by remote copying. In these pairs, the VOL20, the VOL21, and the VOL22 are PVOLs, and the VOL30, the VOL31, and the VOL32 are SVOLs. These three pairs constitute a copy group CG23.

Further, the VOL30, the VOL31 and the VOL32 make pairs P3040, P3141, and P3242 with the VOL40, the VOL41 and the VOL42 by local copying. In these pairs, the VOL30, the VOL31 and the VOL32 are PVOLs, and the VOL40, the VOL41 and the VOL42 are SVOLs. These three pairs constitute a copy group CG34.

Next, referring to FIG. 4, this invention will be summarized. Here, the VOL10, the VOL20, the VOL30, and the VOL40 only will be described. It should be understood that the description applies to the other logical volumes 144.

When pair statuses of all the pairs shown in FIG. 4 are “PAIR”, for example, upon updating of the data of the VOL10 of the DKC1 by the application server 120, the updating is reflected in the VOL20 and the VOL30 by remote copying, and further reflected in the VOL40 by local copying. As a result, identical data are stored in the VOL10, the VOL20, the VOL30, and the VOL40.

Next, when “SPLIT” is executed for the pair P2030, a pair status of the pair P2030 becomes “SUSPEND”, and the remote copying of the pair P2030 is stopped.

Subsequently, when the data of the VOL10 is updated, the updating is reflected in the VOL20 by remote copying. However, since the remote copying of the pair P2030 is stopped, the updating is not reflected in the VOL30 and the VOL40. As a result, data stored in the VOL10 and the VOL20 is not identical to that stored in the VOL30 and the VOL40.

Subsequently, when “RESYNC” is executed for the pair P2030, a pair status becomes “COPY”, and the data of the VOL20 is copied to the VOL30. After the completion of the copying, the pair status becomes “PAIR”. At this time, among data stored in the VOL30 before a start of the copying, data different from that of the VOL20 is lost by the copying.

Further, since the pair status of the pair P3040 is “PAIR”, updating of the data of the VOL30 is reflected in the VOL40. As a result, among data stored in the VOL40, data different from that of the VOL20 is lost.

When a storage system manager performs a pair operation, the data management program 201 of this invention determines data (data contained in the VOL30 and the VOL40 in the example of FIG. 4) which is likely to be lost by the pair operation, and notifies the user of the data. For example, the user who has received the notification can cancel the pair operation. Further, the user may execute “SPLIT” for the pair P3040 before it executes “RESYNC” for the pair P2030. As a result, the updating of the data of the VOL30 is no longer reflected in the VOL40, and the data of the VOL40 is saved.

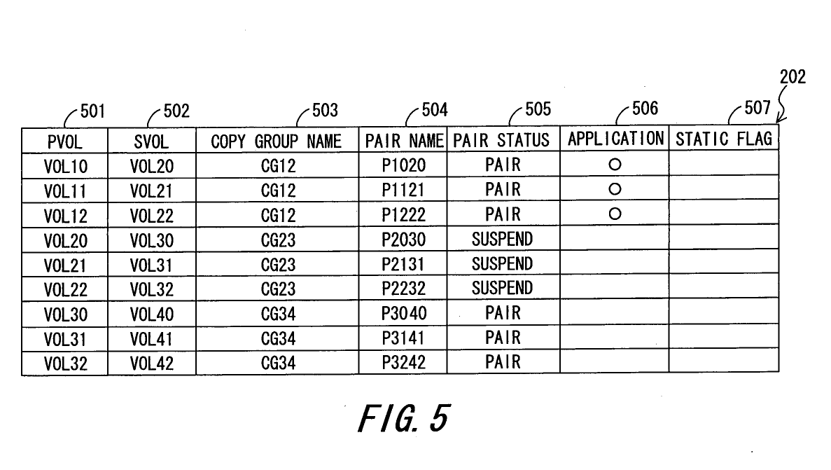

FIG. 5 is an explanatory diagram showing the pair status/application status management table 202 according to the embodiment of this invention.

The pair status/application status management table 202 contains information for managing the data of the logical volumes 144, and is referred to by the data management program 201.

FIG. 5 shows contents of the pair status/application status management table 202 when there are pairs and copy groups similar to those of FIG. 4 in the computer system of FIG. 1. One line of the pair status/application status management table 202 corresponds to a pair present in the storage system 140 managed by the system management server 100.

Referring to FIG. 5, PVOL501 and SVOL502 are names of PVOL and SVOL which make a pair. “VOL10”, “VOL20”, and the like are written in the PVOL501 and the SVOL502.

A copy group name 503 is a name of a copy group to which each pair belongs. For example, “CG12” is written in the copy group name 503.

A pair name 504 is a name of each pair. “P1020” or the like is written in the pair name 504.

A pair status 505 is a pair status of each pair. One of “PAIR”, “SUSPEND”, “COPY”, and “ERROR” is written in the pair status 505. In the example of FIG. 5, pair statuses of the pairs P2030, P2131, and P2232 are “SUSPEND”, and pair statuses of other pairs are “PAIR”. This indicates in FIG. 4 that remote copying or local copying is executed for pairs belonging to the copy groups CG12 and CG34, and remote copying is stopped for pairs belonging to the copy group CG23.

An application 506 indicates a pair which contains logical volumes 144 in which applications are executed by the application server 120 (i.e., data I/O is directly received from the application server 120). In the example of FIG. 5, since the application server 120 that uses the DKC1 executes applications, “O” is written for pairs which include the VOL10, the VOL11, and the VOL12.

A static flag 507 indicates whether an application is static or not. Staticizing means that data access (I/O) from the application server 120 to the logical volume 144 is stopped. While the application is static, “O” is written for a pair which directly supplies an application. Only a pair for which “O” is written in the application 506 is a target.

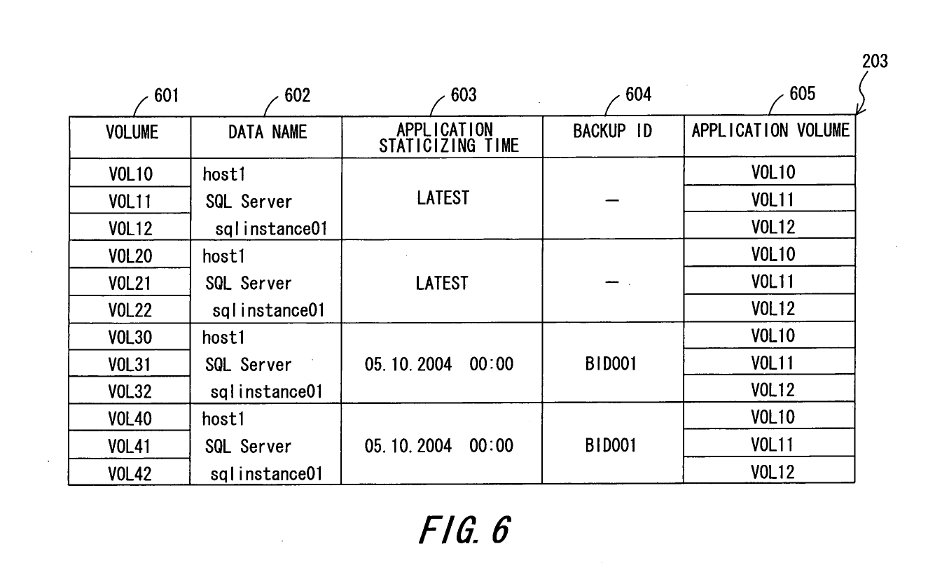

FIG. 6 is an explanatory diagram showing the volume/data correspondence management table 203 according to the embodiment of this invention.

The volume/data correspondence management table 203 contains information for managing the data of the logical volumes 144, and is referred to by the data management program 201.

FIG. 6 shows contents of the volume/data correspondence management table 203 when there are pairs and copy groups similar to those of FIG. 4 in the computer system of FIG. 1 similarly to that of FIG. 5. One line of the volume/data correspondence management table 203 corresponds to one logical volume 144 present in the storage system 140 managed by the system management server 100.

Referring to FIG. 6, a volume 601 is a name of each logical volume 144. “VOL10”, “VOL20”, or the like is written in the volume 601.

A data name 602 is a name for identifying data stored in each logical volume 144. For example, data is identified by an application which has created the data, the application server 120 which has executed the application, and a name of an instance.

In the example of FIG. 6, data of the VOL10 to VOL12 are created by an application “SQL SERVER” of the application server 120 whose name is “HOST1”, and instance name is “SQL INSTANCE01”. It should be noted that the “HOST1” is a name of the application server 120 which uses the DKC1.

The VOL20 to VOL22 are copies of the VOL10 to VOL12. Thus, data names 602 of the VOL20 to VOL22 are similar to those of the VOL10 to VOL12. The same holds true for the VOL30 to VOL32 and the VOL40 to VOL42.

An application staticizing time 603 is a time of staticizing an application for each logical volume 144. Referring to FIG. 6, since the VOL10 to VOL12 and the VOL20 to VOL22 are not static, “LATEST” is written in the application staticizing time 603. On the other hand, since the VOL30 to VOL32 and the VOL40 to VOL42 are static, a staticizing time (“05. 10. 2004 00:00” in the example of FIG. 6) is written in the application staticizing time 603.

A backup ID 604 is a backup identifier. A value of the backup ID 604 is given when the application is staticized for each logical volume 144. Identical backup ID's 604 are provided to logical volumes 144 in which data names 602 and application staticizing times 603 are the same. On the other hand, a different backup ID 604 is provided to a logical volume 144 in which at least one of the data name 602 and the application staticizing time 603 is different. Referring to FIG. 6, since the VOL10 to VOL12 and the VOL20 to VOL22 are not static, the column of the backup ID 604 is blank. On the other hand, since the VOL30 to VOL32 and the VOL40 to VOL42 are static, a backup ID (“BID001” in the example of FIG. 6) given at the time of staticizing is written in the backup ID 604.

An application volume 605 is a logical volume 144 which receives data I/O from the application server 120 among the logical volumes 144 on the copy path which includes each logical volume 144.

It should be noted that the copy path is a group of cascade-connected pairs. For example, referring to FIG. 4, the cascade-connected P1020, P2030, and P3040 constitute one copy path.

Referring to FIG. 4, the VOL10, the VOL20, the VOL30 and the VOL40 belong to the same copy path. Among the logical volumes 144, the VOL10 receives the data I/O from the application server 120. Accordingly, an application volume 605 of the VOL40 is VOL10. Similarly, an application volume 605 of each of the VOL30 and the VOL20 is VOL10.

Meanwhile, an application volume 605 of each of the VOL21, the VOL31, and the VOL41 is VOL11. Similarly, an application volume 605 of each of the VOL22, the VOL32, and the VOL42 is VOL12.

The volume/data correspondence management table 203 may contain information regarding a mount point for each logical volume 144.

FIG. 7 is an explanatory diagram showing a pair constitution definition table 302 according to the embodiment of this invention.

FIG. 7 shows the pair constitution definition table 302 of the application server 120 which uses the DKC1 in the example of FIG. 4.

Referring to FIG. 7, a volume 701 is a name of a logical volume contained in the DKC1. In the example of FIG. 7, “VOL10”, “VOL11”, and “VOL12” are written in the volume 701.

A copy group name 702 is a name of a copy group to which the logical volumes 144 belong. In the example of FIG. 7, “CG12” is written in the copy group name 702 of the VOL10 to the VOL12.

A pair name 703 is a pair name to which the logical volumes 144 belong. In the example of FIG. 7, “P1020”, “P1121” and “P1222” are written in the pair name of the VOL10, the VOL11 and the VOL12.

In the pair constitution definition table 302 of the application server 120 which uses the DKC2 and the DKC3 (not shown), as in the previous case, names of the logical volume 144 contained in the DKC2 or the DKC3, and a copy group and a pair name to which they belong are written.

The pair constitution definition table 302 is referred to when the system management server 100 creates the pair status/application status management table 202 and the volume/data correspondence management table 203, and updates contents in the tables to latest ones.

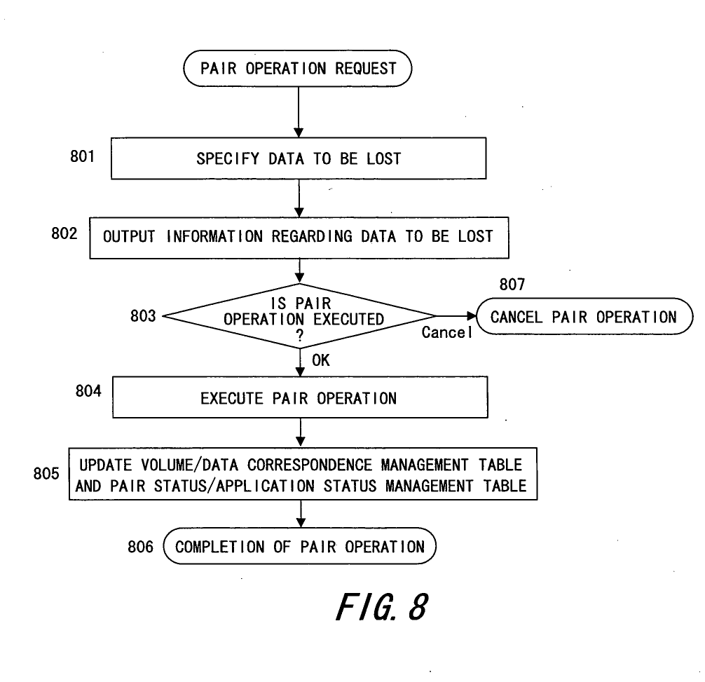

FIG. 8 is a flowchart of a process executed by the data management program 201 when the user requests a pair operation in the computer system according to the embodiment of this invention.

The process of FIG. 8 is started when the user requests a pair operation of the system management server 100. The request of the pair operation includes information to designate a pair name to be a target of a pair operation and a type of the pair operation (i.e., any one of “SPLIT”, “RESYNC”, and “RESTORE”).

As the precondition for executing the process, contents of the pair status/application status management table 202 and the volume/data correspondence management table 203 must be latest. Specifically, the system management server 100 obtains information regarding contents of the tables from each application server 120, and updates the tables. The updating may be executed before or after the reception of the pair operation request from the user.

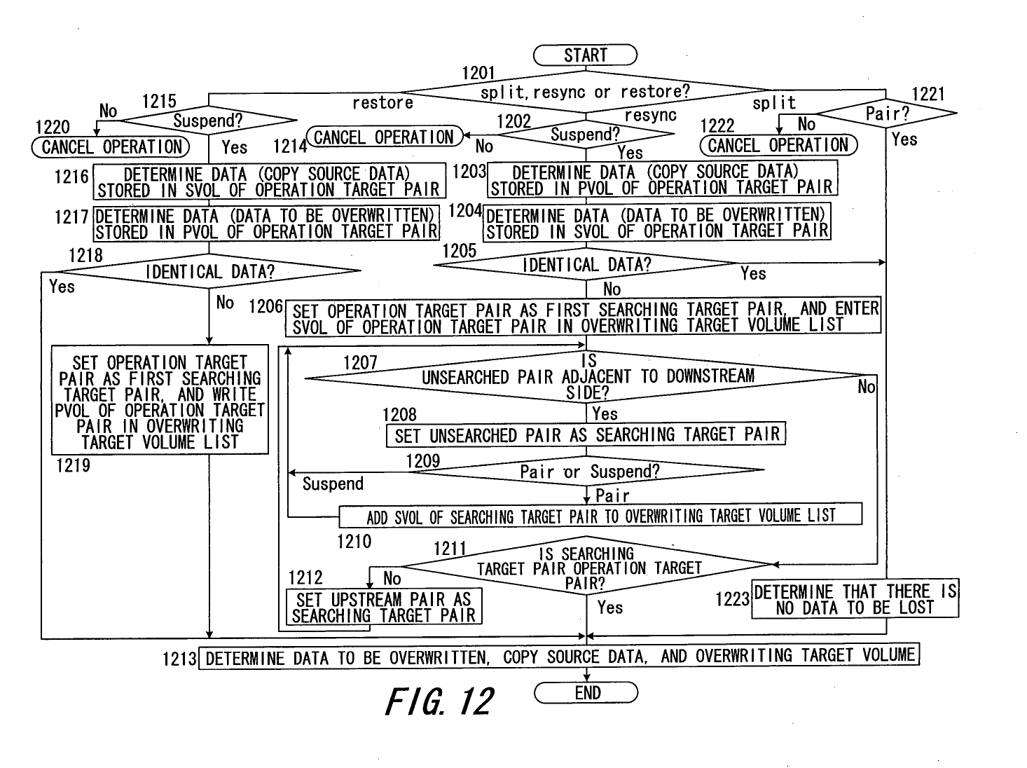

Upon the start of the process of FIG. 8 in response to the pair operation request from the user, the data management program 201 determines data to be lost from the logical volume 144 by the pair operation (801). The process of the operation will be detailed later referring to FIG. 12.

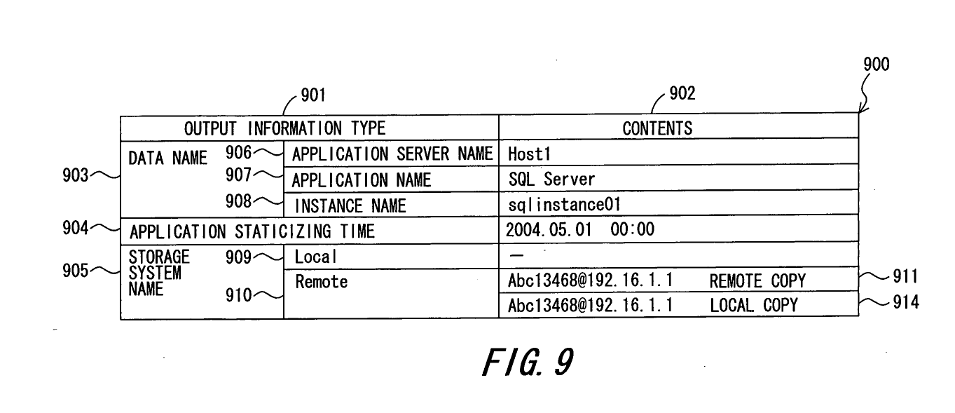

Next, the data management program 201 outputs information regarding data (i.e., data to be lost by the pair operation) determined in the step 801 (802). Specifically, information regarding a name (identifier) of the data, an application staticizing time, a name (identifier) of a storage system or the like are output from the I/O unit of the system management server 100. The information output at this time will be detailed later referring to FIG. 9.

Next, the data management program 201 receives an input indicating whether or not to execute a pair operation (803). Specifically, after the output of the information regarding the data to be lost (802), a request of an input indicating whether or not to execute a pair operation may be output, and an input from the user may be received. The user refers to the information regarding the data to be lost to determine whether or not to execute a pair operation, and a result of the determination can be input by the I/O unit.

Upon reception of an input indicating non-execution of the pair operation from the user in the step 803, the data management program 201 cancels the pair operation, and ends the process (807).

On the other hand, upon reception of an input indicating execution of a pair operation from the user, the data management program 201 executes the pair operation (804). Specifically, the data management program 201 instructs execution of the pair operation to the pair management program 301 of each application server 120, and the pair management program 301 executes the pair operation.

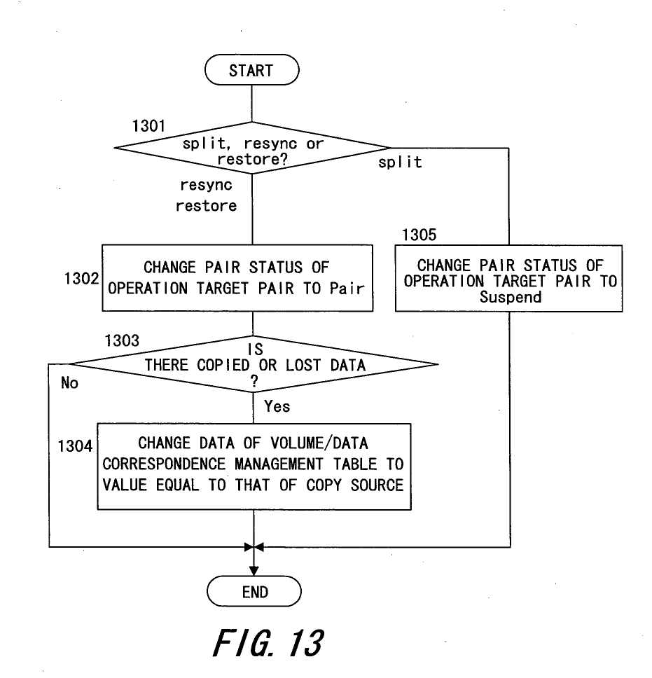

Next, the data management program 201 updates contents of the pair status/application status management table 202 and the volume/data correspondence management table 203 to coincide with ones after the execution of the pair operation (805) and ends the process (806). The updating process will be detailed later referring to FIG. 13.

As described above, upon the reception of the pair operation request from the user, the data management program 201 does not immediately execute the operation but determines data to be lost by the pair operation and notifies the user of the data. When the user desires to lose the data, the user can execute the pair operation. On the other hand, when the user desires to save the data, the user can cancel the pair operation. The user can execute the pair operation again after carrying out the process of protecting the data. As a result, it is possible to prevent occurrence of data loses not expected by the user which is caused by the pair operation.

FIG. 9 is an explanatory diagram showing information regarding data to be lost by a pair operation which is output by the data management program 201 according to the embodiment of this invention.

FIG. 9 shows information output in the step 802 when in the examples of FIGS. 4, 5, and 6, the process shown in FIG. 8 is executed to change the pair between the DKC2 and the DKC3 from “SUSPEND” to “PAIR” (i.e., pair operation “RESYNC” is executed).

When the pair status between the DKC2 and the DKC3 is “SUSPEND”, latest data are stored in the logical volumes 144 in the DKC1 and the DKC2. However, data which is not latest is stored in the logical volume 144 in the DKC3 as shown in FIG. 6. Thus, when “RESYNC” is executed for the pair between the DKC2 and the DKC3, latest data is overwritten in the logical volume 144 in the DKC3, and data which are not latest (i.e., data of VOL30 to VOL32 and VOL40 to VOL42 of FIG. 6) are lost. Accordingly, in the step 802 of FIG. 8, information 900 regarding the data to be lost is output.

Among the information 900 regarding the data to be lost, an output information type 901 indicates a type of information to be output, and contains a data name 903, an application staticizing time 904, and a storage system name 905. The data name 903 contains an application server name 906, an application name 907, and an instance name 908. The data name 903 may contain other information to identify the data to be lost. The storage system name 905 is classified into a local 909 and a remote 910.

Contents 902 correspond to the output information type 901. In the example of FIG. 9, data to be lost are those of the VOL30 to VOL32 and the VOL40 to VOL42 of FIG. 6. Thus, the contents 902 of the data name 903 are similar to those of the data name 602 of the logical volumes 144. In other words, an application server name 906 is “HOST 1”, an application name 907 is “SQL SEVER”, and an instance name is “SQL INSTANCE 01”.

Similarly, the contents 902 of the application staticizing time 904 are “05.10 2004 00:00” similar to those of the application staticizing time 603 of FIG. 6.

Contents 902 of the storage system name 905 are names (identifiers) of storage systems 140 in which data to be lost are stored. Here, one line corresponds to one logical volume in which the data to be lost is stored.

The storage system name 905 is classified into local 909 and remote 910. The local 909 is a storage system 140 in which a logical volume directly used in application by the application server 120 is stored. The remote 910 is a storage system 140 which includes a logical volume connected to the logical volume by remote copying (may be connected by remote copying of a plurality of stages). In the example of FIG. 4, the DKC1 is classified into local 909 since it is used in application by the application server 120. The DKC2 and the DKC3 are classified into remote 910 since they are not used in application by the application server 120.

Referring to FIGS. 4 and 6, the data to be lost is not stored in the DKC1. Thus, the column of contents 902 of the local 909 is blank.

Referring to FIGS. 4 and 6, the data to be lost is stored in the DKC3. Thus, contents 902 of the remote 910 are identifiers of the DKC3.

A line 911 corresponds to the VOL30. Here, “Abc13468@192.16.1.1” is an identifier of the DKC3 in which the VOL30 is stored. “(REMOTE COPY)” indicates copying of data stored in the VOL30 from the other storage system 140 (in this case, DKC2) by remote copying.

A line 914 corresponds to the VOL40. The VOL40 is stored in the DKC3 as in the case of the VOL30. Thus, in contents 902 of the VOL40, an identifier “Abc13468@192.16.1.1” of the DKC3 is written. On the other hand, data stored in the VOL40 has been copied from the other logical volume 144 (in this case, VOL30) in the same storage system 140 by local copying. Thus, in the contents 902 of the VOL40, “(LOCAL COPY)” is further written.

The information 900 regarding the data to be lost may be output as text data from the I/O unit 101. For example, it may be output together with a drawing such as a configuration diagram of the computer system.

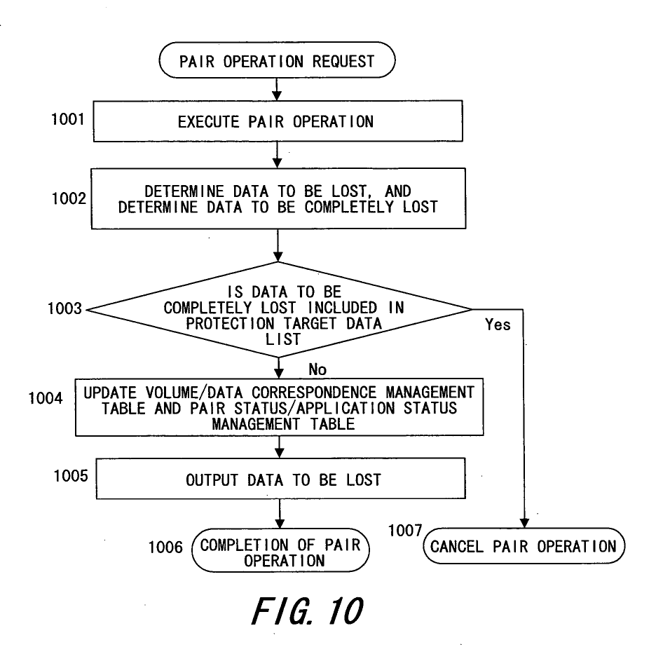

FIG. 10 is a flow chart of a process executed by the data management program 201 when a pair operation is requested by a batch job in the computer system according to the embodiment of this invention.

When a pair operation is requested by a batch job, unlike the case in which the pair operation is requested by the user as shown in FIG. 8, an output of data to be lost by the pair operation or an input indicating whether or not to execute a pair operation is not requested. Instead, a list of data protected from being lost (protection target data list) is provided. Further, when data to be completely lost by the pair operation is determined, and the data is contained in the protection target data list, the pair operation is canceled.

The data to be lost by the pair operation is data lost from a specific logical volume by the pair operation. Accordingly, data identical to the data lost by the pair operation may be left in the other logical volume on the copy path. On the other hand, the data completely lost by the pair operation are data lost from all the logical volumes 144 on the copy path including the pair by the pair operation.

The protection target data list (not shown) is a list of a data name 602 and an application staticizing time 603 of data protected from being lost by the pair operation. The user can register data not to be lost by the pair. operation in the protection target data list. When data of a given data name 602 is protected irrespective of the application staticizing time 603, the application staticizing time 603 does not need to be designated. The protection target data list is stored in, e.g., the disk device 102 of the system management server 100.

Additionally, the data to be completely lost by the pair operation is data not left in any one of the logical volumes 144 associated by remote copying or local copying. For example, referring to FIGS. 4 to 6, when the pair operation “RESYNC” is executed for the pair P2030, the data of the VOL20 is overwritten in the VOL30 and the VOL40. At this time, the data of the VOL30 and the VOL40 are completely lost. However, if the pair operation “SPLIT” is executed for the pair P3040 before the execution of the pair operation “RESYNC” for the pair P2030, the data of the VOL20 is not overwritten in the VOL40. In other words, the data of the VOL30 is lost by the pair operation “RESYNC”, while the data identical to that of the VOL30, which is stored in the VOL40 is not lost. In this case, the data is not completely lost.

Next, a process of FIG. 10 will be described. In the process of FIG. 10, detailed description of portions similar to those of the process of FIG. 8 will be omitted.

In the process of FIG. 10, as in the case of the process of FIG. 8, contents of the pair status/application status management table 202 and the volume/data correspondence management table 203 must be latest.

Upon the start of the process of FIG. 10 by a pair operation request from a batch job, the data management program 201 executes the pair operation (1001). Specifically, the data management program 201 instructs the pair management program 301 of each application server 120 to execute the pair operation, and the pair management program 301 executes the pair operation.

Next, the data management program 201 determines data to be lost by the pair operation (1002). The process will be detailed later referring to FIG. 12. Further, in the step 1002, the data management program 201 determines data to be completely lost by the pair operation.

Next, the data management program 201 determines whether the data to be completely lost, which has been determined in the step 1002 is contained in the protection target data list (1003).

If the data to be completely lost is contained in the protection target data list, the data is protected from being lost by the pair operation. Thus, the data management program 201 cancels the pair operation executed in the step 1001, and ends the process (1007).

On the other hand, if the data to be completely lost is not contained in the protection target data list, the data is not protected from being lost by the pair operation. Thus, the data management program 201 updates contents of the pair status/application status management table 202 and the volume/data correspondence management table 203 to coincide with a status after the execution of the pair operation (1004). The updating process will be detailed later referring to FIG. 13.

Next, the data management program 201 outputs information 900 regarding the data to be lost by the pair operation from the I/O unit of the system management server 100 (1005). Then, the process ends (1006).

Next, the process of determining the data to be lost by the pair operation which is executed in the step 801 of FIG. 8 and the step 1002 of FIG. 10 will be described.

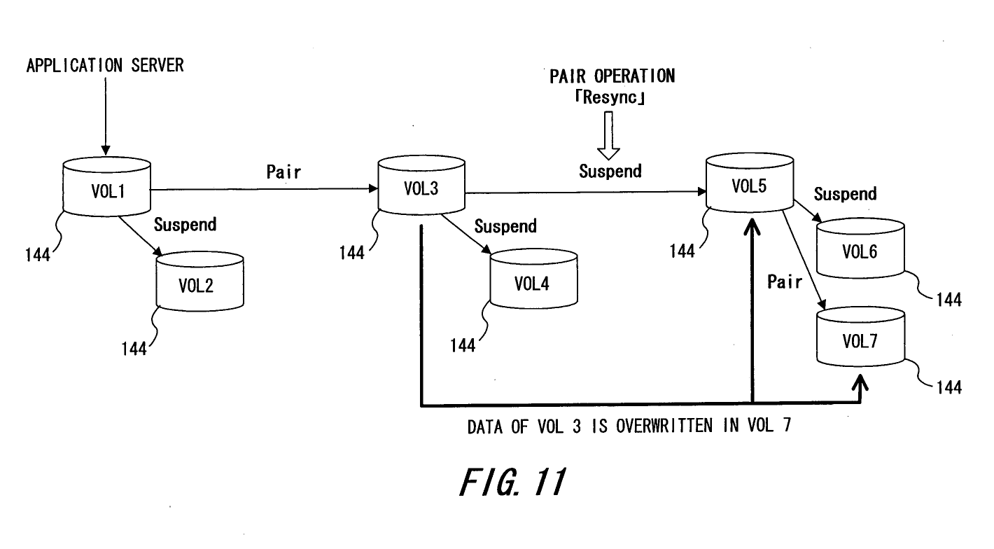

FIG. 11 is a schematic explanatory diagram showing a process of determining data to be lost by a pair operation according to the embodiment of this invention.

Here, FIG. 11 shows a specific example of a process of FIG. 12 (detailed later).

In the example of FIG. 11, VOL1 to VOL7 are logical volumes 144 on one copy path.

The VOL1 and the VOL2 constitute a pair P12. In the pair P12, the VOL1 is PVOL, the VOL2 is SVOL, and a pair status is “SUSPEND”.

The VOL1 and the VOL3 constitute a pair P13. In the pair P13, the VOL1 is PVOL, the VOL3 is SVOL, and a pair status is “PAIR”.

The VOL3 and the VOL4 constitute a pair P34. In the pair P34, the VOL3 is PVOL, the VOL4 is SVOL, and a pair status is “SUSPEND”.

The VOL3 and the VOL5 constitute a pair P35. In the pair P35, the VOL3 is PVOL, the VOL5 is SVOL, and a pair status is “SUSPEND”.

The VOL5 and the VOL6 constitute a pair P56. In the pair P56, the VOL5 is PVOL, the VOL6 is SVOL, and a pair status is “SUSPEND”.

The VOL5 and the VOL7 constitute a pair P57. In the pair P57, the VOL5 is PVOL, the VOL7 is SVOL, and a pair status is “PAIR”.

The starting point of an arrow indicating each pair is on the PVOL side, and a tip thereof is on the SVOL side.

On a copy path which includes the VOL1 to VOL7, the PVOL side is defined as an upstream side, and the SVOL side is defined as a downstream side. For example, when a pair 35 is used as a reference, a pair 13 is on the upstream side, and pairs P56 and P57 are on the downstream side. The pair P13 is adjacent to the upstream side of the pair P35, and the pairs P56 and P57 are adjacent to the downstream side of the pair P35. On the other hand, the pair P13 is on the upstream side of the pair P56, but not adjacent thereto.

Next, a process of determining data to be lost when a pair operation “RESYNC” is executed for the pair P35 will be described.

In the case of executing the pair operation “RESYNC” for the pair P35, first, data of the PVOL (VOL3) and the SVOL (VOL5) are compared with each other for the operation target pair P35. Specifically, referring to the volume/data correspondence management table 203, values of backup ID's 604 of the VOL3 and the VOL5 are compared with each other (in FIG. 6, VOL3 and VOL5 are omitted).

If the values of the backup ID's 604 are equal, identical data are stored in the VOL3 and the VOL5. Thus, since no data is lost by the pair operation, the process ends.

If the values of the backup ID's 604 are different, the data stored in the VOL3 and the data stored in the VOL5 are at least partially different from each other. Accordingly, there is data to be lost by the pair operation in the VOL5.

Next, a pair status of the pair P56 on the downstream side of the pair P35 is referred to. Specifically, reference is made to a pair status 506 of the pair status/application status management table 202 (in FIG. 5, the pair P56 is omitted). In the example of FIG. 11, since the pair status 506 of the pair P56 is “SUSPEND”, data of the VOL6 is not lost by the pair operation.

Next, since there is no pair on the downstream side of the pair P56, reference is made to a pair status of another pair P57 on the downstream side of the pair P35. In the example of FIG. 11, since the pair status of the pair P57 is “PAIR”, there is data to be lost by the pair operation in the VOL7.

Then, searching for the pair P35 which is a pair operation target, and all pairs on the downstream side thereof is completed. As a result, if there is a difference in data between the VOL3 and the VOL5, it can be understood that the data of the VOL5 and the VOL7 are lost by the pair operation.

FIG. 12 is a flowchart showing a process of determining data to be lost by the pair operation according to the embodiment of this invention.

Upon the start of the process of determining data to be lost by the pair operation, the data management program 201 determines a type of the pair operation (1201).

If the pair operation is determined to be “RESYNC”, then, determination is made as to whether a pair status of a target pair of the pair operation (operation target pair) is “SUSPEND” (1202). Specifically, for the pair, reference is made to a pair status 506 of the pair status/application status management table 202. As a result, if the pair status is not “SUSPEND”, since the pair operation “RESYNC” cannot be executed, the pair operation is canceled (1214).

On the other hand, if the pair status of the pair is “SUSPEND”, the pair operation “RESYNC” can be executed. Accordingly, next, data of the PVOL of the operation target pair (i.e., copy source data) is determined (1203). Specifically, for the PVOL, reverence is made to a value of a backup ID 604 of the volume/data correspondence management table 203.

Next, similarly, data of the SVOL of the operation target pair (i.e., data on which data of the PVOL is overwritten) is determined (1204).

Next, determination is made as to whether the data of the PVOL and the data of the SVOL are identical (1205). Specifically, determination is made as to whether the value of the backup ID 604 of the PVOL referred to in the step 1203 and the value of the backup ID 604 of the SVOL referred to in the step 1204 are equal to each other. As a result, if the values are equal, since no data is lost by the pair operation “RESYNC” (1223), the process proceeds to a step 1213.

On the other hand, if the data of the PVOL and the data of the SVOL are not identical, there is data to be lost by the pair operation “RESYNC” in the SVOL. Accordingly, the SVOL of the operation target pair is entered in an overwriting target volume list (not shown) (1206). The overwriting target volume list is a list of logical volumes 144 which contain data to be lost by the pair operation.

Additionally, there may be a case in which data of logical volumes 144 on the downstream side of the operation target pair are lost. Specifically, data of logical volumes 144 interconnected by one or more pairs whose pair statuses are “PAIR” on the downstream side of the SVOL are lost. Thus, to determine the logical volumes whose data are lost on the downstream side, searching for pairs on the downstream side is started with the operation target pair set as a first searching target pair.

Next, determination is made as to whether pairs adjacent to the downstream side of the searching target pair include unsearched pairs (1207). If unsearched pairs are included, the unsearched pairs are set as searching target pairs (1208).

Next, determination is made as to whether a pair status of the searching target pairs is “PAIR” or “SUSPEND” (1209).

If the pair status of the searching target pair is “SUSPEND”, data of the SVOL of the searching target pair and the logical volume 144 on the downstream side thereof are not lost by the pair operation. Thus, the searching target pair is set as searched. To search for other pairs, the process returns to the step 1207.

On the other hand, if the pair status of the searching target pair is “PAIR”, the SVOL of the searching target pair is connected to the SVOL of the operation target pair by one or more pairs whose pair statuses are “PAIR”. In other words, data of the SVOL of the searching target pair is lost by the pair operation. Thus, the SVOL is added to the overwriting target volume list (1210). Then, the searching target pair is set as searched. To search for other pairs, the process returns to the step 1207.

On the other hand, if no unsearched pair is included in the step 1207, searching for all the pairs on the downstream side of the searching target pair has been finished. Accordingly, to determine whether searching for all the pairs on the downstream side of the operation target pair has been finished, determination is made as to whether the searching target pair is an operation target pair (1211).

If the searching target pair is not an operation target pair, searching for all the pairs on the downstream side of the operation target pair has not been finished. Accordingly, to search for other pairs, the searching target pair is set as searched, a pair adjacent to the upstream side of the searching target pair is set as a new searching target pair (1212), and the process returns to the step 1207.

On the other hand, if the searching target pair is an operation target pair, searching for all the pairs on the downstream side of the operation target pair has been finished. Thus, copy source data copied by the pair operation, data to be lost by overwriting of the copy source data (i.e., data to be lost by the pair operation), and a logical volume 144 which contains data to be lost is determined (1213).

On the other hand, if the pair operation is “RESTORE” in the step 1201, determination is made as to whether a pair status of the operation target pair is “SUSPEND” (1215). If the pair status is not “SUSPEND”, since the pair operation “RESTORE” cannot be executed, the pair operation is canceled (1220).

If the pair status of the operation target pair is “SUSPEND” in the step 1215, the pair operation “RESTORE” can be executed. Thus, next, data of SVOL of the operation target pair (i.e., copy source data) is determined (1216). Specifically, for the SVOL, reference is made to a value of the backup ID 604 of the volume/data correspondence management table 203.

Next, similarly, data of the PVOL of the operation target pair (i.e., data on which data of the SVOL is overwritten) is determined (1217).

Next, determination is made as to whether the data of the PVOL and the data of the SVOL are identical (1218). Specifically, determination is made as to whether the value of the backup ID 604 of the SVOL referred to in the step 1216 and the value of the backup ID 604 of the PVOL referred to in the step 1217 are equal to each other. As a result, if the values are equal, since no data is lost by the pair operation “RESYNC”, the process proceeds to the step 1213.

On the other hand, if the data of the PVOL and the data of the SVOL are not identical, there is data to be lost by the pair operation “RESYNC” in the PVOL. Accordingly, the PVOL of the operation target pair is entered in an overwriting target volume list (1219). After that, the process proceeds to the step 1213.

On the other hand, if the pair operation is “SPLIT” in the step 1201, determination is made as to whether the pair status of the operation target pair is “PAIR” (1221). If the pair status is not “PAIR”, since the pair operation “SPLIT” cannot be executed, the pair operation is canceled (1222).

If the pair status of the operation target pair is “PAIR” in the step 1221, the pair operation “SPLIT” can be executed. There is no data to be lost by the pair operation “SPLIT” (1223). Thus, the process proceeds to the step 1213.

Thus, the process of determining the data to be lost by the pair operation ends.

Next, description will be made of a process of updating contents of the pair status/application status management table 202 and the volume/data correspondence management table 203 executed after the pair operation (i.e., step 805 of FIG. 8 and step 1004 of FIG. 10) (table updating process after pair operation).

FIG. 13 is a flowchart showing a table updating process after the pair operation according to the embodiment of this invention.

Upon the start of the table updating process after the pair operation, the data management program 201 determines a type of the executed pair operation (1301).

If the executed pair operation is “RESYNC” or “RESTORE”, for the operation target pair, a pair status 505 of the pair status/application status management table 202 is changed to “PAIR” (1302).

Next, determination is made as to whether there is data copied or lost by the pair operation (1303).

If there is data copied or lost by the pair operation, for a logical volume 144 in which the data is stored (or has been stored), a data name 602, an application staticizing time 603, and a value of the backup ID 604 of the volume/data correspondence management table 203 are changed to be equal to a value of a logical volume 144 of a data copy source (1304). Then, the process ends.

On the other hand, if there is no data copied or lost by the pair operation, the process ends.

If the executed pair operation is “SPLIT” in the step 1301, for the operation target pair, the pair status 505 of the pair status/application status management table 202 is changed to “SUSPEND” (1305). Then, the process ends.

Next, description will be made of a process executed by the data management program 201 when a change of an application status or pair operation is requested by the user or a batch job. The change of the application status is one of application staticizing and application destaticizing.

While an application is static, the application server 120 writes no data in the logical volume 144. Accordingly, in the static status of the application, unless the pair operation is executed, no data of the logical volume 144 is lost. On the other hand, when the application is destaticized, the application server 120 can write data in the logical volume 144. Upon overwriting of data in the logical volume 144 by the application server 120, old data is lost.

In the following process, the data management program 201 determines not only data to be lost by the pair operation but also data to be lost by application status change.

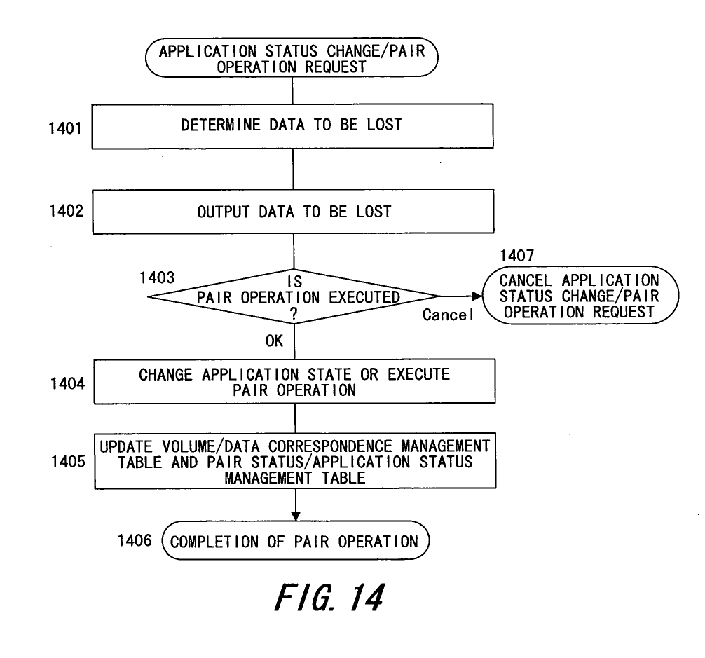

FIG. 14 is a flowchart showing a process executed by the data management program 201 when the user requests application status change or pair operation in the computer system according to the embodiment of this invention.

In the following description, detailed explanation of portions common to those of the process of FIG. 8 (process executed by the data management program 201 when the user requests a pair operation) will be omitted.

The process of FIG. 14 is started when the user requests application change or pair operation of the system management server 100. The request to change the application status contains information for designating application staticizing or destaticizing.

It should be noted that in the case of the process of FIG. 8, as the preconditions for executing the following process, contents of the pair status/application status management table 202 and the volume/data correspondence management table 203 must be latest.

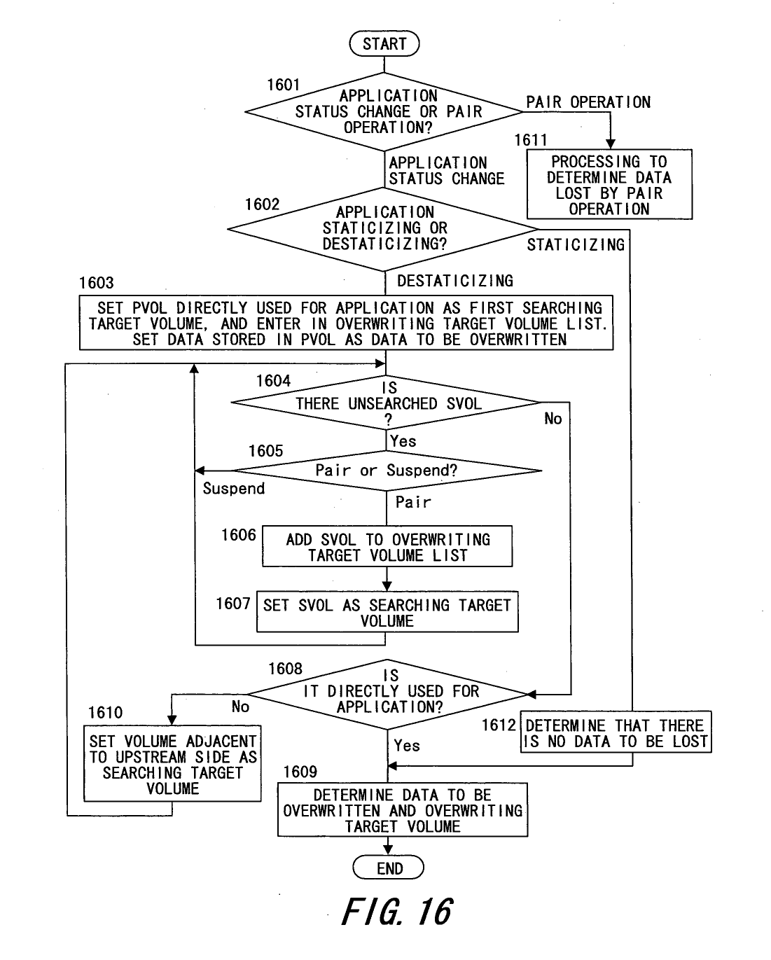

Upon the start of the process of FIG. 14 by the request of application status change or pair operation from the user, the data management program 201 determines data to be lost by the application status change or pair operation (1401). This process will be detailed later referring to FIG. 16.

Next, the data management program 201 outputs information 900 shown in FIG. 9 regarding data determined in the step 1401 (i.e., data to be lost by the application status change or the pair operation) (1402).

Next, the data management program 201 receives an input indicating whether or not to execute the application change or the pair operation (1403). Specifically, after the information regarding the data to be lost is output (1402), a request of an input indicating whether or not to execute the application status change or the pair operation may be output, and an input from the user may be received. The user refers to the information regarding the data to be lost to determine whether or not to execute the application status change or the pair operation, and can input a result of the determination with the I/O unit.

Upon reception of nonexecution of the application status change or the pair operation from the user in the step 1403, the data management program 201 cancels the application status change or the pair operation, and ends the process (1407).

Upon reception of execution of the application status change or the pair operation from the user in the step 1403, the data management program 201 executes the application status change or the pair operation (1404).

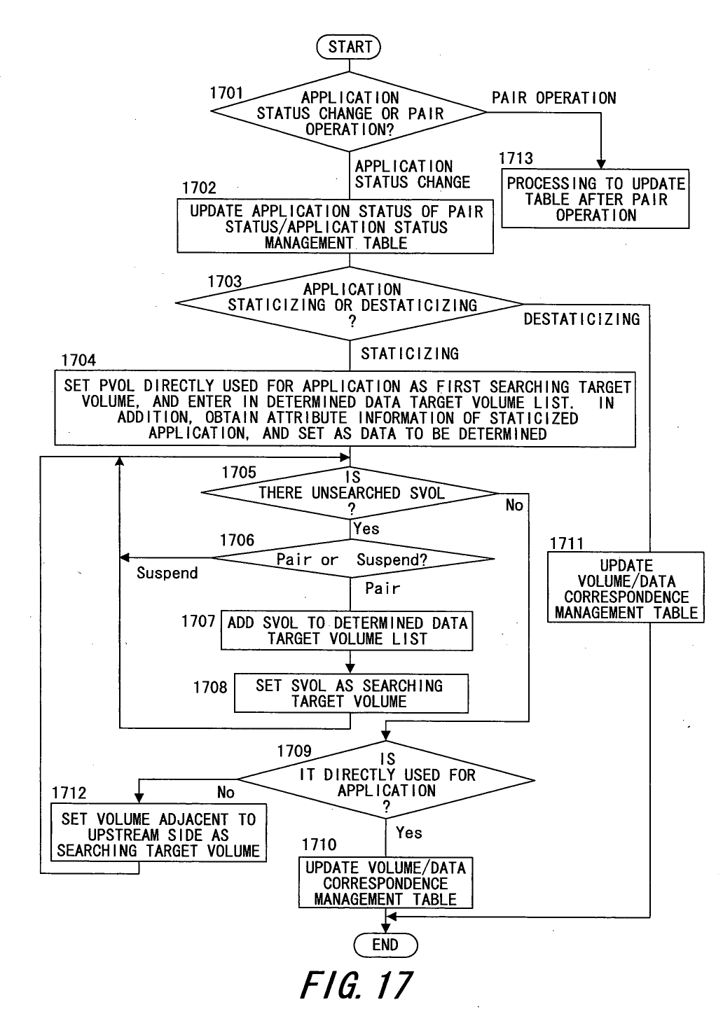

Next, the data management program 201 updates the contents of the pair status/application status management table 202 and the volume/data correspondence management table 203 to coincide with a status after the execution of the application status change or the pair operation (1405), and ends the process (1406). The updating process will be detailed later referring to FIG. 17.

As a result of the process, it is possible to prevent occurrence of data loss not intended by the user which is caused by the application status change or the pair operation.

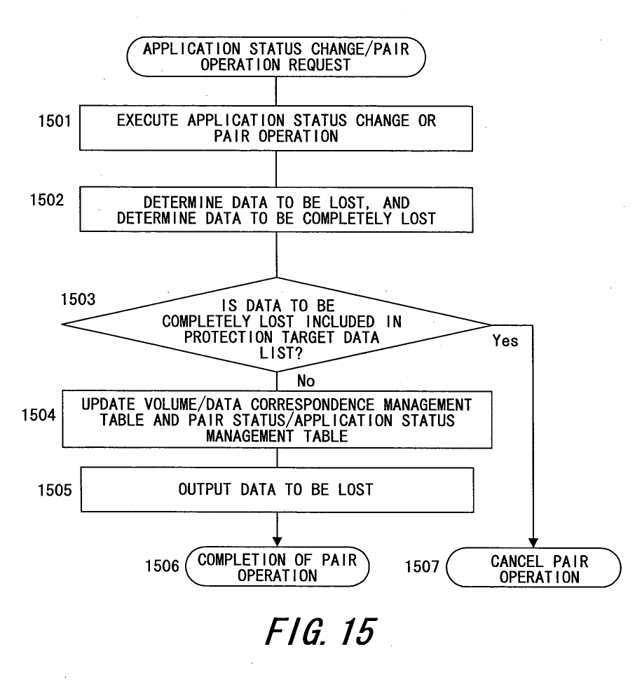

FIG. 15 is a flowchart showing a process executed by the data management program 201 when the application status change or pair operation is requested by a batch job in the computer system according to the embodiment of this invention.

In the following description, detailed explanation of portions similar to those of the process of FIG. 10 (process executed by the data management program 201 when the pair operation is requested by the batch job) will be omitted.

Upon the start of the process of FIG. 10 by an application status change or pair operation request from a batch job, the data management program 201 executes the application status change or the pair operation (1501).

Next, the data management program 201 determines data to be lost by the application status change or the pair operation (1502). The process will be detailed later referring to FIG. 16. Further, in the step 1502, the data management program 201 determines data to be completely lost by the application status change or the pair operation.

Next, the data management program 201 determines whether the data to be completely lost, which has been determined in the step 1502 is contained in the protection target data list (1503).

If the data to be completely lost is contained in the protection target data list, the data is protected from being lost by the application status change or the pair operation. Thus, the data management program 201 cancels the application status change or the pair operation executed in the step 1501, and ends the process (1507).

On the other hand, if the data to be completely lost is not contained in the protection target data list, the data is not protected from being lost by the application status change or the pair operation. Thus, the data management program 201 updates contents of the pair status/application status management table 202 and the volume/data correspondence management table 203 to coincide with a status after the execution of the application status change or the pair operation (1504). The updating process will be detailed later referring to FIG. 17.

Next, the data management program 201 outputs information 900 regarding the data to be lost by the application status change or the pair operation from the I/O unit of the system management server 100 (1505). Then, the process ends (1506).

FIG. 16 is a flowchart showing a process of determining data to be lost by the application status change or the pair operation according to the embodiment of this invention.

The process is executed in the step 1401 of FIG. 14 and in the step 1502 of FIG. 15.

Upon the start of the process of determining data, to be lost by the application status change or the pair operation, the data management program 201 determines which of the application status change and the pair operation has been executed (1601).

If it is determined that the pair operation has been executed, the process of determining data to be lost by the pair operation is executed (1611). This process is similar to that of FIG. 12, and thus description thereof will be omitted.

On the other hand, if it is determined that the application status change has been executed, determination is next made as to which of application staticizing and application destaticizing has been executed (1602). If the application staticizing has been executed, since no data is lost (1612), the process proceeds to a step 1609.

On the other hand, if the application destaticizing has been executed, data may be lost. Thus, next, a logical volume 144 directly used in application (i.e., logical volume 144 directly accessed from the application server) is set as a first searching target logical volume 144 (searching target volume). Further, the searching target volume is entered in an overwriting target volume list. It should be noted that the overwriting target volume list is similar to that of FIG. 12. Data stored in the searching target volume is set as data to be overwritten (1603).

Additionally, in some cases, data of logical volumes 144 on the downstream side of the searching target volume are lost. Specifically, data of logical volumes 144 interconnected by one or more pairs whose pair statuses are “PAIR” on the downstream side of the searching target volume are lost. Thus, to determine the logical volumes 144 whose data are lost on the downstream side, searching for pairs on the downstream side of the searching target volume is started.

Next, determination is made as to whether or not there is SVOL which makes a pair with the searching target volume and which is unsearched (1604).

If there is SVOL which makes a pair with the searching target volume and which is unsearched, the searching for logical volumes 144 on the downstream side of the searching target volume has not been finished. Thus, next, determination is made as to whether a pair status of the pair of the searching target volume and the unsearched SVOL is “PAIR” or “SUSPEND” (1605).

If the pair status is “SUSPEND”, no data of the SVOL is lost. Thus, the SVOL is set as searched, and the process returns to the step 1604 to investigate other SVOL. At this time, no data of the logical volumes 144 on the downstream side of the SVOL is lost. Thus, it is not necessary to search for the logical volumes 144 on the downstream side of the SVOL.

On the other hand, if the pair status is “PAIR”, the SVOL is connected to the directly used logical volume 144 by one or more pairs whose pair statuses are “PAIR”. In other words, data of the SVOL is lost. Thus, the SVOL is added to the overwriting target volume list (1606).

Next, the searching target pair is set as searched, the SVOL is set as a new searching target volume (1607), and the process returns to the step 1604.

On the other hand, if there is no SVOL which makes a pair with the searching target volume and which is unsearched in the step 1604, searching for all the logical volumes on the downstream side of the searching target volume has been finished. Accordingly, next, determination is made as to whether the searching target volume is a logical volume 144 directly used in the application or not (1608).

If the searching target volume is not a logical volume 144 directly used in the application, there may be a remaining unsearched logical volume 144. Thus, to search for an unsearched logical volume 144, the searching target volume is set as searched, a logical volume 144 adjacent to the upstream side of the logical volume 144 which is set as searched is set as a new searching target volume (1610), and the process returns to the step 1604.

On the other hand, if the searching target volume is a logical volume 144 directly used in application, searching for all the logical volumes 144 has been finished. Thus, data to be overwritten and an overwriting target volume are determined (1609), and the process ends.

Next, description will be made of a process of updating contents of the pair status/application status management table 202 and the volume/data correspondence management table 203 executed after the application status change or the pair operation (i.e., step 1405 of FIG. 14 and step 1504 of FIG. 15) (table updating process after application status change or pair operation).

FIG. 17 is a flowchart showing a table updating process after the application status change or the pair operation according to the embodiment of this invention.

Upon the start of the table updating process after the application status change or the pair operation, the data management program 201 determines which of the application status change and the pair operation has been executed (1701).

If it is determined that the pair operation has been executed, the table updating process after the pair operation is executed (1713). This process is similar to that of FIG. 13, and thus detailed description thereof will be omitted here.

On the other hand, if the application status change is executed, the pair status/application status management table 202 is updated (1702). Specifically, a value of an application 506 of the pair status/application status management table 202 is updated to a value after the application status change.

Next, determination is made as to which of application staticizing and destaticizing has been executed (1703).

If it is determined that the application destaticizing has been executed, contents of the volume/data correspondence management table 203 are updated (1711), and the process ends. Specifically, for the overwriting target volume, an application staticizing time 603 is set as “LATEST”, and a value of a backup ID 604 is deleted.

On the other hand, if it is determined that the application staticizing has been executed, since access from the application server 120 to the logical volume 144 is stopped, data of the logical volume is determined. Thus, next, a logical volume 144 directly used in application (i.e., logical volume 144 directly accessed from the application server) is set as a first searching target logical volume 144 (searching target volume). Further, the searching target volume is entered in a determined data target volume list (not shown) (1704).

The determined data target volume list is a list of logical volumes 144 whose data are determined by application staticizing.

Furthermore, in the step 1704, attribute information regarding the staticized application is obtained, and the attribute data is set as data to be determined. Here, the attribute information regarding the application is a data name 602, an application staticizing time 603, a backup ID 604 or the like regarding the application.

Next, determination is made as to whether there is SVOL which makes a pair with the searching target volume and which is unsearched (1705).

If there is SVOL which makes a pair with the searching target volume and which is unsearched, the searching for logical volumes 144 on the downstream side of the searching target volume has not been finished. Thus, next, determination is made as to whether a pair status of the pair of the searching target volume and the unsearched SVOL is “PAIR” or “SUSPEND” (1706).

If the pair status is “SUSPEND”, the SVOL is set as searched, and the process returns to the step 1705 to investigate other SVOL.

On the other hand, if the pair status is “PAIR”, the SVOL is added to the determined data target volume list (1707).

Next, the searching target volume is set as searched, the SVOL is set as a new searching target volume, and the process returns to the step 1705.

On the other hand, if there is no SVOL which makes a pair with the searching target volume and which is unsearched in the step 1705, searching for all the logical volumes 144 on the downstream side of the searching target volume has been finished. Accordingly, next, determination is made as to whether the searching target volume is a logical volume 144 directly used in application (1709).

If the searching target volume is not a logical volume 144 directly used in application, there may be a remaining unsearched logical volume 144. Thus, to search for an unsearched logical volume 144, the searching target volume is set as searched, a logical volume 144 adjacent to the upstream side of the logical volume 144 which is set as searched is set as a new searching target volume (1712), and the process returns to the step 1705.

On the other hand, if the searching target volume is a logical volume 144 directly used in application, searching for logical volumes 144 has been finished. Thus, next, the volume/data correspondence management table 203 is updated (1710). Specifically, for the logical volume 144 entered in the determined data target volume list, the data name 602, the application staticizing time 603 and the backup ID 604 are updated.

Thus, the table updating process after the application status change or the pair operation ends.

Next, description will be made of a process executed when data is lost by the application status change or the pair operation.

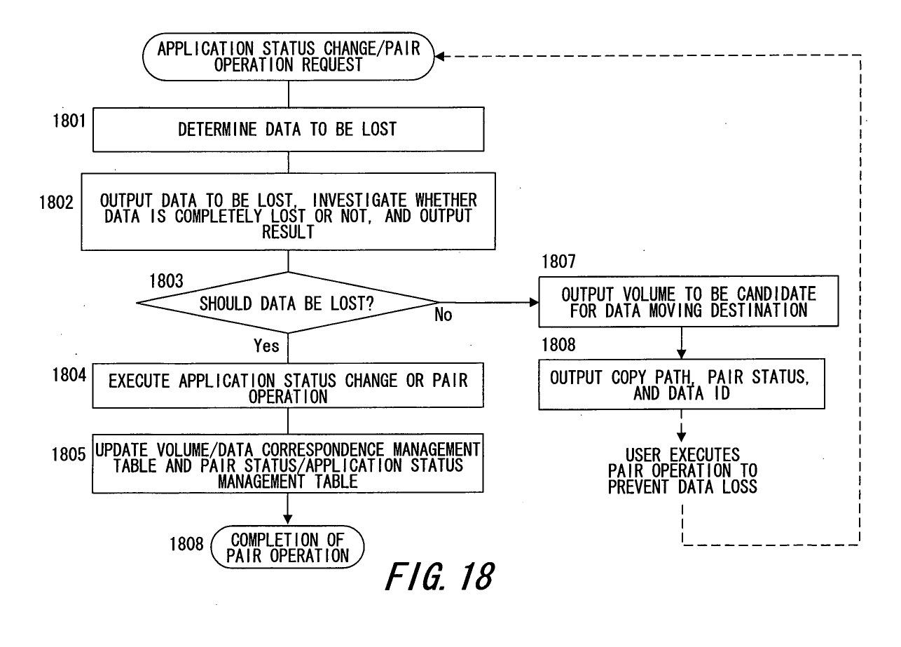

FIG. 18 is a flow chart showing a process executed by the data management program 201 when data is lost by the application status change or the pair operation according to the embodiment of this invention.

The process of FIG. 18 is started by the user requesting the application status change or pair operation of the system management server 100.

As in the case of the process of FIG. 8, as the preconditions for executing the following process, contents of the pair status/application status management table 202 and the volume/data correspondence management table 203 must be latest.

Upon the start of the process of FIG. 18 by an application status change or pair operation request from the user, the data management program 201 determines data to be lost by the application status change or the pair operation (1801). The process is similar to that shown in FIG. 16.

Next, the data management program 201 outputs information 900 shown in FIG. 9 regarding the data determined in the step 1801 (i.e., data to be lost by the application status changing or the pair operation) (1802). Further, the data management program 201 refers to the volume/data correspondence management table to check whether such data is to be lost completely lost by the application status change or the pair operation, and outputs a result thereof.

Next, the data management program 201 determines whether or not to lose the data output in the step 1802 (1803). Specifically, after the output of the information regarding the data to be lost (1802), a request of an input indicating whether or not to execute the application status change or the pair operation may be output, and an input from the user may be received. At this time, if the request to execute the application status change or the pair operation is input from the user, it is determined that the data can be lost. On the other hand, if the request to executing no application status change or pair operation is input from the user, it is determined that the data should be saved.

If it is determined that the data can be lost in the step 1803, the data management program 201 executes the application status change or the pair operation (1804).

Next, the data management program 201 updates contents of the pair status/application status management table 202 and the volume/data correspondence management table 203 to coincide with a status after the execution of the application status change or the pair operation (1805), and the process ends (1808). The updating process is as shown in FIG. 17.

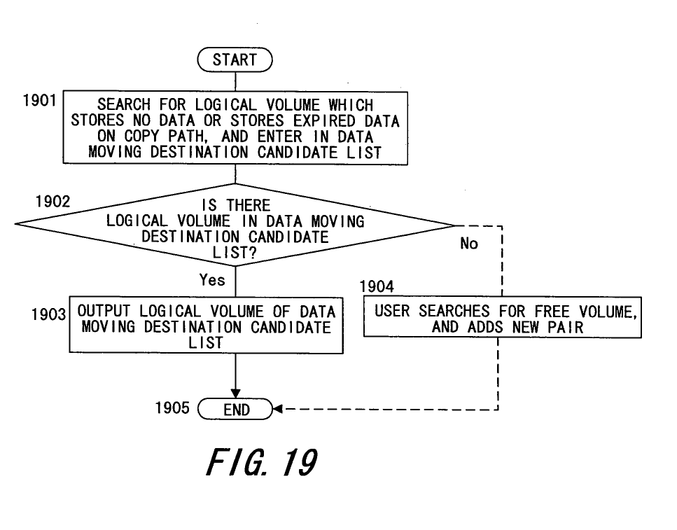

On the other hand, if it is determined that the data should be saved in the step 1803, the data is moved to another logical volume 144, and a process to protect the data from being lost is executed. First, the data management program 201 searches for a logical volume 144 which becomes a candidate of data moving destination, and outputs a result thereof (1806). The searching will be detailed later referring to FIG. 19.

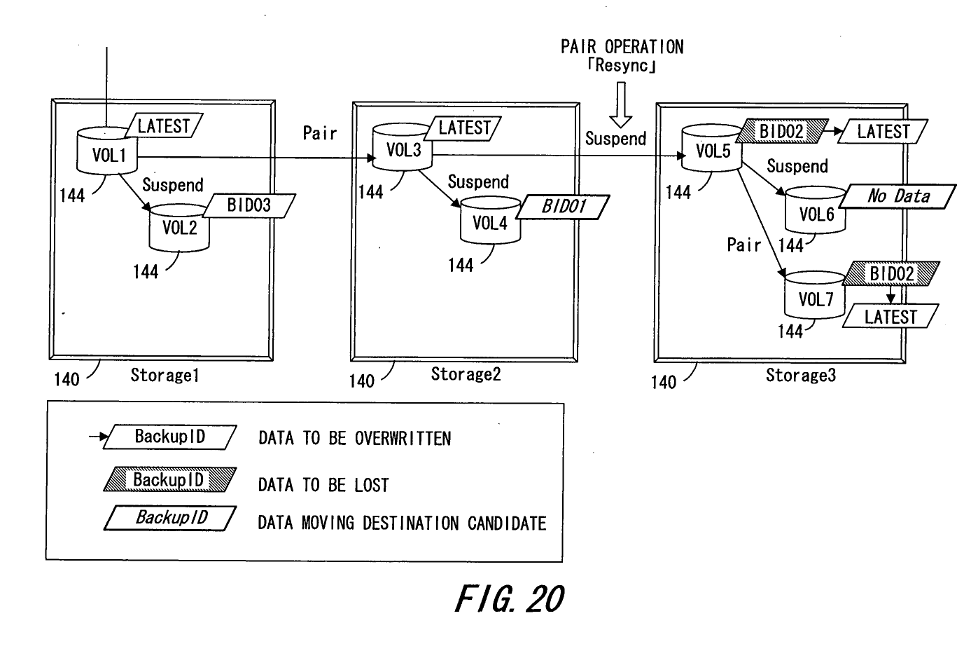

Next, the data management program 201 outputs a copy path which includes the logical volume 144 as the candidate of the movement destination of the data searched for in the step 1806, a pair status of a pair in the copy path, and a data ID of data stored in each logical volume (1807). These pieces of information may be displayed on the screen by using the I/O unit 101. An example of screen display will be detailed later referring to FIG. 20.

The user may refer to such pieces of information to execute the pair operation not to lose the data, and execute the process of FIG. 18 again.

FIG. 19 is a flowchart showing a process of searching for a logical volume 144 which becomes a candidate of data moving destination executed according to the embodiment of this invention.

The searching is executed by the data management program 201 in the step 1806 of FIG. 18.

Upon the start of the process of FIG. 19, the data management program 201 searches for a logical volume 144 in which no data is stored or a logical volume 144 in which expired data (i.e., it may be discarded) is stored on the copy path which includes the logical volume 144 in which the data to be lost is stored, and enteres the logical volume 144 obtained as a result of the searching in a data moving destination candidate list (not shown) (1901).

The data moving destination candidate list is a list of logical volumes 144 obtained by the searching in the step 1901 (i.e., logical volumes 144 in which the data to be lost can be stored).

Next, determination is made as to whether one or more logical volumes 144 are contained or not in the data moving destination candidate list created in the step 1901 (1902).

If one or more logical volumes 144 are contained in the movement destination candidate list, there are logical volumes 144 in which the data to be lost can be stored on the logical path. Accordingly, these logical volumes 144 are output (displayed) (1903). At this time, the logical volumes 144 contained in the movement destination candidate list may be displayed as shown in FIG. 20.

On the other hand, if no logical volume 144 is contained in the movement destination candidate list, there is no logical volume in which the data to be lost can be stored on the copy path. In this case, for example, the user searches for a free logical volume 144 in the storage system 140, and can add a new pair including the free logical volume 144 to the copy path when the free logical volume 144 is found (1904).

Thus, the process of searching for the logical volume 144 which becomes a data moving destination candidate ends.

FIG. 20 is an explanatory diagram showing screen display of the data to be lost and the candidates of data moving destination according to the embodiment of this invention.

FIG. 20 shows an example of the screen display output in the step 1807 of FIG. 18.

For example, the screen display is output from a display screen (not shown) of the I/O unit 101 of the system management server 100.

Referring to FIG. 20, storages 1 to 3 are storage systems 140.

The VOL1 and the VOL2 are logical volumes 144 stored in the storage 1.

The VOL3 and the VOL4 are logical volumes 144 stored in the storage 2.

The VOL5, the VOL6, and the VOL7 are logical volumes 144 stored in the storage 3.

The VOL1 to the VOL7 constitute one copy path. Pair names and pair statuses are similar to those of the VOL1 to the VOL7 of FIG. 11, and thus detailed description will be omitted.

Referring to FIG. 20, pairs P13 and P35 are made by remote copying, and pairs P12, P34, P56, and P57 are made by local copying.

Referring to FIG. 20, a pair status of the pair P35 is first “SUSPEND”. At this time, data of which backup ID's 604 are “LATEST” are stored in the VOL1 and the VOL3. In the VOL2, data of which the backup ID 604 is “BID03” is stored. In the VOL4, data of which the backup ID 604 is “BID01” is stored. In the VOL5 and the VOL7, data of which the backup ID's 604 are “BID02” are stored. In the VOL6, no data is stored (“NoData”).

FIG. 20 shows an example of screen display when the user requests the pair P35 to execute a pair operation “RESYNC”. Upon the execution of the pair operation “RESYNC” for the pair P35, data “LATEST” of the VOL3 is copied to the VOL5. As a result, the data “BID02” of the VOL5 is lost. Further, since a pair status of the pair P57 is “PAIR”, the data “LATEST” is copied from the VOL5 to the VOL7. As a result, the data “BID02” of the VOL7 is also lost. Therefore, no data “BID02” is lost in any logical volumes 144 on the copy path of FIG. 20. In other words, the data “BID02” are completely lost.

In the example of FIG. 20, the data “BID02” to be lost are indicated by hatching. Additionally, the data “LATEST” overwritten on the data to be lost are indicated by arrows.

On the other hand, the data “BID01” stored in the VOL4 can be discarded because its preservation term has expired. No data is stored in the VOL6. Thus, the VOL4 and the VOL6 are movement destination candidates of the data to be lost, “BID02”.

In the example of FIG. 20, the movement destination candidate data “BID01” of the data to be lost, “BID02” and the “No_Data” are indicated in italic.

Thus, before the execution of the pair operation, the data to be lost by the pair operation and the movement destination candidate thereof are displayed. By watching the display, the user can determine whether or not to lose the data “BID02”. Further, if the user desires to save the data “BID02”, the user can move the data “BID02” to one of the logical volumes displayed as the movement destination candidates of the data “BID02”.

For example, “RESYNC” is executed for the pair P56 before “RESYNC” is executed for the pair P35. As a result, the data “BID02” is copied to the VOL6. Subsequently, “SPLIT” is executed for the pair P56. As a result, a pair status of the pair P56 becomes “SUSPEND”. Then, “RESYNC” is executed for the pair P35, whereby the data “BID02” are lost from the VOL5 and the VOL7 but left in the VOL6.

Alternatively, “SPLIT” may be executed for the pair P57 before “RESYNC” is executed for the pair P35. In this case, the data “BID02” is left in the VOL7.

According to the embodiment, when the user requests the execution of the application status change or the pair operation, the data to be lost by the execution is determined, and displayed to the user. Additionally, the movement destination candidate of the lost data is displayed. If the user desires to save the data, the user can execute a process for saving the data such as moving the data to the logical volume which is a movement destination candidate.

When the execution of the application status change or the pair operation is requested by the batch job, the data to be completely lost is determined. Then, if the data is contained in the protection target list, the execution of the application status change or the pair operation is canceled.

In other words, when the user changes the pair status or the like, which data on the copy path is lost by the change or the like is displayed. Referring to the display, the user can change the pair status or the like while checking whether or not to lose the data. As a result, it is possible to prevent occurrence of data losses not intended by the user.

The logical volume which is a movement destination candidate of the data to be lost is displayed. If the user desires to save the data, the user can easily protect the data by moving the data to the logical volume of the movement destination candidate.

Additionally, even when data arrangement on the copy path is changed due to the change of the pair status or the data movement, it is possible to easily know correct correspondence between the logical volume and the data. Thus, the data arrangement on the copy path can be flexibly changed.

Furthermore, since the pair status change or the like can be executed while checking the data arrangement, it is not necessary to preset complex scripts of pair operations for recovering data at construction phase for system setting.

What is claimed is:

1. A computer system comprising:
a storage system; and
a system management server which manages the computer system including the storage system, wherein:
the storage system comprises:
a primary logical volume which stores data; and
a secondary logical volume which stores a copy of the data stored in the primary logical volume,
the primary logical volume and the secondary logical volume constituting a pair;
the system management server:
comprises a data management unit which manages the data stored in the logical volumes; and
stores management information to manage the data stored in the logical volumes and the pair; and
upon reception of a request for changing a pair status, the data management unit refers to the management information and determines data to be lost from the logical volume by the changing of the pair status, and outputs information regarding the data to be lost.

2. The computer system according to claim 1, wherein:
the management information comprises identifiers of the data stored in the logical volumes and information regarding a pair status;
the pair status comprises:
a first status in which updated data is copied to the secondary logical volume when the data stored in the primary logical volume is updated; and
a second status in which the copying of the updated data is stopped;
the data management unit determines that, when split which changes the first status to the second status is requested, no data is to be lost from the logical volume by the split, compares the identifier of the data stored in the primary logical volume with the identifier of the data stored in the secondary logical volume when resync which changes the second status to the first status is requested, and determines that, when both identifiers are different, the data of the different identifier of the secondary logical volume is to be lost from the secondary logical volume by the changing of the pair status.

3. The computer system according to claim 2, wherein:
the storage system further comprises a third logical volume which stores a copy of the data stored in the secondary logical volume;
the pair status further comprises a third status in which updated data is copied to the third logical volume when the data stored in the secondary logical volume is updated; and
the data management unit further determines that, when the data stored in the secondary logical volume is determined to be lost and the pair status of the secondary logical volume and the third logical volume is the third status, data corresponding to the data determined to be lost from the secondary logical volume among the data stored in the third logical volume is to be lost from the third logical volume.

4. The computer system according to claim 1, wherein the data management unit outputs information regarding the data determined to be lost from the logical volume, then cancels the requested changing of the pair status upon reception of an instruction not to execute the changing, and executes the changing of the pair status upon reception of an instruction to execute the changing.

5. The computer system according to claim 4, wherein after the changing of the pair status, the data management unit refers to the changed pair status and the data copied by the changing, and updates the management information.

6. A computer system comprising:
a storage system; and
a system management server which manages the computer system including the storage system, wherein:
the storage system comprises:
a primary logical volume which stores data;
a secondary logical volume which stores a copy of the data stored in the primary logical volume; and
a third logical volume which stores a copy of the data stored in the secondary logical volume,
the primary logical volume and the secondary logical volume constituting a pair;
the system management server:
comprises a data management unit which manages the data stored in the logical volumes; and
stores management information to manage the data stored in the logical volumes and the pair,
the management information comprising identifiers of the data stored in the logical volumes and information regarding a pair status;
the status of the pair comprises:
a first status in which updated data is copied to the secondary logical volume when the data stored in the primary logical volume is updated;
a second status in which the copying of the updated data is stopped; and
a third status in which updated data is copied to the third logical volume when the data stored in the secondary logical volume is update;
the pair is subjected to operations comprised of:
split which changes the first status to the second status; and
resync which changes the second status to the first status;
upon reception of a request for changing the status of the pair, the data management unit determines that no data is to be lost from the logical volume by the changing when the requested changing of the pair status is the split, compares the identifier of the data stored in the primary logical volume with the identifier of the data stored in the secondary logical volume when the requested changing of the pair status is the resync, and determines that, when both identifiers are different from each other, the data of the different identifier of the secondary logical volume is to be lost from the secondary logical volume by the changing of the pair status;
the data management unit further determines that, when the data stored in the secondary logical volume is determined to be lost and the pair status of the pair of the secondary logical volume and the third logical volume is the third status, data corresponding to the data determined to be lost from the secondary logical volume among the data stored in the third logical volume is to be lost from the third logical volume, outputs information regarding the data determined to be lost, cancels the requested changing of the pair status upon reception of an instruction not to execute the changing, executes the changing of the pair status upon reception of an instruction to execute the changing, and subsequently refers to the changed pair status and the data copied by the changing, and updates the management information.

7. A computer system comprising:
a storage system; and
a system management server which manages the computer system including the storage system, wherein:
the storage system comprises:
a primary logical volume which stores data; and
a secondary logical volume which stores a copy of the data stored in the primary logical volume,
the primary logical volume and the secondary logical volume constituting a pair;
the system management server:
comprises a data management unit which manages the data stored in the logical volumes; and
stores management information to manage the data stored in the logical volumes and the pair,
upon reception of a request for changing a pair status, the data management unit executes the changing of the pair status, refers to the management information and determines data to be lost from the logical volume by the changing of the pair status, refers to the management information and determines data to be completely lost from a data copy path including the pair, determines whether the data to be completely lost is a protection target, cancels the executed changing of the pair status when the data to be completely lost is the protection target, and outputs information regarding the data to be lost from the logical volume when the data to be completely lost is the protection target.

8. A computer system comprising:
a system management server;
an application server coupled to the system management server;
a storage system coupled to the application server, wherein:
the storage system comprises:
a primary logical volume which stores data used in application by the application server; and
a secondary logical volume which stores a copy of the data stored in the primary logical volume,
the primary logical volume and the secondary logical volume constituting a pair;
the system management server:
comprises a data management unit which manages the data stored in the logical volumes; and
stores management information to manage the data stored in the logical volumes and the pair; and
upon reception of a request for changing a status of data access to the logical volume from the application server, the data management unit refers to the management information and determines data to be lost from the logical volume by the changing of the status, and outputs information regarding the data to be lost from the logical volume.

9. The computer system according to claim 8, wherein:
the management information comprises an identifier of the data stored in the logical volume and information regarding a pair status;
the changing of the status of the data access comprises staticizing which stops access to the data stored in the logical volume by the application server, and destaticizing which starts the access to the data stored in the logical volume by the application server; and
the data management unit determines that, when the requested changing of the data access status is the staticizing, no data is to be lost from the logical volume by the changing, and determines that, when the requested changing of the data access status is the destaticizing, the data stored in the access target logical volume are lost therefrom.

10. The computer system according to claim 9, wherein:
the storage system further comprises a third logical volume which stores a copy of the data stored in the secondary logical volume;
the pair status comprises:
a first status in which updated data is copied to the secondary logical volume when the data stored in the primary logical volume is updated;
a second status in which the copying of the updated data is stopped; and
a third status in which updated data is copied to the third logical volume when the data stored in the secondary logical volume is updated,
the data management unit further determines that, when the data stored in the secondary logical volume is determined to be lost and the pair status of the pair of the secondary logical volume and the third logical volume is the third status, data corresponding to the data determined to be lost from the secondary logical volume among the data stored in the third logical volume is to be lost from the third logical volume.

11. The computer system according to claim 8, wherein the data management unit outputs information regarding the data determined to be lost from the logical volume, then cancels the requested changing of the data access status upon reception of an instruction not to execute the changing, and executes the changing of the data access status upon reception of an instruction to execute the changing.

12. The computer system according to claim 11, wherein, after the changing of the data access status, the data management unit refers to the data copied by the changing and updates the management information.

13. A computer system comprising:
a system management server;
an application server coupled to the system management server;
a storage system coupled to the application server, wherein:
the storage system comprises:
a primary logical volume which stores data used in application by the application server; and
a secondary logical volume which stores a copy of the data stored in the primary logical volume,
the primary logical volume and the secondary logical volume constituting a pair;
the system management server:
comprises a data management unit which manages the data stored in the logical volumes; and
stores management information to manage the data stored in the logical volumes and the pair; and
upon reception of a request for changing a status of data access to the logical volume from the application server, the data management unit executes the changing of the status, refers to the management information and determines data to be lost from the logical volume by the changing of the status, refers to the management information and determines data to be completely lost from a data copy path including the data access executed logical volume by the changing of the status, determines whether the data to be completely lost is a protection target, cancels the executed changing of the data access status when the data to be completely lost is the protection target, and outputs information regarding the data to be lost from the logical volume when the data to be completely lost is the protection target.

14. A system management server which manages a computer system comprising a storage system,
the storage system comprising:
a primary logical volume which stores data; and
a secondary logical volume which stores a copy of the data stored in the primary logical volume,
the primary logical volume and the secondary logical volume constituting a pair,
the system management server:
comprising a data management unit which manages the data stored in the logical volumes; and
storing management information to manage the data stored in the logical volumes and the pair,
wherein, upon reception of a request for changing a status of the pair, the data management unit refers to the management information and determines data to be lost from the logical volume by the changing of the status, and outputs information regarding the data to be lost.

15. The system management server according to claim 14, wherein:
the management information comprises identifiers of the data stored in the logical volumes and information regarding a pair status;
the storage system further comprises a third logical volume which stores a copy of the data stored in the secondary logical volume;
the status of the pair comprises:
a first status in which updated data is copied to the secondary logical volume when the data stored in the primary logical volume is updated;
a second status in which the copying of the updated data is stopped; and
a third status in which updated data is copied to the third logical volume when the data stored in the secondary logical volume is updated;
upon reception of the request for changing the pair status, the data management unit
determines that no data is to be lost from the logical volume by split when the split which changes the first status to the second status is requested,
compares the identifier of the data stored in the primary logical volume with the identifier of the data stored in the secondary logical volume when resync which changes the second status to the first status is requested, and determines that, when both identifiers are different, the data of the different identifier of the secondary logical volume is to be lost from the secondary logical volume by the changing of the pair status; and
the data management unit further determines that, when the data stored in the secondary logical volume is determined to be lost and the pair status of the pair of the secondary logical volume and the third logical volume is the third status, data corresponding to the data determined to be lost from the secondary logical volume among the data stored in the third logical volume is to be lost from the third logical volume, outputs information regarding the data determined to be lost, then cancels the requested changing of the pair status upon reception of an instruction not to execute the changing, executes the changing of the pair status upon reception of an instruction to execute the changing, and subsequently refers to the changed pair status and the data copied by the changing of the pair status, and updates the management information.

16. A method of controlling a computer system comprising a storage system, and a system management server which manages the computer system including the storage system,
the storage system comprising:
a primary logical volume which stores data; and
a secondary logical volume which stores a copy of the data stored in the primary logical volume;
the primary logical volume and the secondary logical volume constituting a pair,
the system management server:
comprising a data management unit which manages the data stored in the logical volumes; and
storing management information to manage the data stored in the logical volumes and the pair,
the method comprising:
a first step of controlling the data management unit to receive a request for changing a pair status;
a second step of referring to the management information and determining data to be lost from the logical volume by the changing of the pair status; and
a third step of outputting information regarding the data to be lost.

17. The method according to claim 16, wherein:
the management information comprises identifiers of the data stored in the logical volumes and information regarding the pair status;
the storage system further comprises a third logical volume which stores a copy of the data stored in the secondary logical volume;
the status of the pair comprises:
a first status in which updated data is copied to the secondary logical volume when the data stored in the primary logical volume is updated;
a second status in which the copying of the updated data is stopped, and
a third status in which updated data is copied to the third logical volume when the data stored in the secondary logical volume is updated;
in the second step,
when split which changes the first status to the second status is requested, no data is determined to be lost from the logical volume by the split, the identifier of the data stored in the primary logical volume is compared with the identifier of the data stored in the secondary logical volume when resync which changes the second status to the first status is requested, and when both identifiers are different, the data of the different identifier of the secondary logical volume is determined to be lost from the secondary logical volume by the changing of the pair status, and
when the data stored in the secondary logical volume is determined to be lost and the pair status of the pair of the secondary logical volume and the third logical volume is the third status, data corresponding to the data determined to be lost from the secondary logical volume among the data stored in the third logical volume is determined to be lost from the third logical volume,
the method further comprising after the third step:
a fourth step of canceling the changing of the pair status upon reception of an instruction not to execute the requested changing;
a fifth step of executing the changing of the pair status upon reception of an instruction to execute the changing; and
a sixth step of referring to the changed pair status and the data copied by the changing, and updating the management information.
